(19) United States
(12) Patent Application Publication
(10) Pub. No.: US 2013/0078740 A1
(43) Pub. Date: Mar. 28, 2013

(54) PREPARATION OF MICROFLUIDIC DEVICE ON METAL NANOPARTICLE COATED SURFACE, AND USE THEREOF FOR NUCLEIC ACID DETECTION

(71) Applicant: University of Rochester, Rochester, NY (US)

(72) Inventors: Benjamin L. MILLER, Penfield, NY (US); Hsin-I PENG, Atlanta, GA (US)

(73) Assignee: UNIVERSITY OF ROCHESTER, Rochester, NY (US)

(21) Appl. No.: 13/625,528

(22) Filed: Sep. 24, 2012

Related U.S. Application Data
(60) Provisional application No. 61/538,537, filed on Sep. 23, 2011.

(51) Int. Cl. G01N 21/64; B82Y 15/00

(52) U.S. Cl. 436/501; 422/69; 977/773; 977/902

(57) ABSTRACT

The invention relates to a microfluidic device that utilizes nucleic acid-based detection and a detection system containing the same, as well as a process for preparing the micro fluidic device and for using the same to detect the presence of a target nucleic acid molecule in a sample.

This application claims the priority benefit of U.S. Provisional Patent Application Ser. No. 61/538,537, filed Sep. 23, 2011, which is hereby incorporated by reference in its entirety.

### FIELD OF THE INVENTION

The present invention relates to a process for manufacturing microfluidic, hybridization-based biosensors, the resulting biosensor devices, and their use in identifying target nucleic acids in samples.

### BACKGROUND OF THE INVENTION

The past two decades have witnessed the rapidly growing use of microfluidic technology in numerous bio-analytical devices including bio-separation systems (Gascoyne et al., Lap Chip 2:70 (2002)), biosensors (Kwak et al., Nature 450:1235 (2007); Bercovici et al., Anal. Chem. 83:4110 (2011)), and on-chip Polymerase Chain Reaction (PCR) devices (Zhang and Xing, Nucleic Acids Res. 35:4223 (2007); Zhang and Ozdemir, Anal. Chim. Acta. 638:115 (2009)). This shift has been driven by the unique set of advantages that micro fluidics provides in the context of bio-analytical studies. The ability to perform operations in a micron scale naturally translates into low reagent and power consumption, low cost, and portability (Myers and Lee, Lab Chip 8:2015 (2008); Chin et al., Lab Chip 7:41 (2007)). At the same time, the micron-size channel height guides analytes to the immediate proximity of the reaction surface very efficiently, thus minimizing diffusion-limit reactions. Moreover, convection flow can rapidly replenish depleted reactants near the reaction surface, thereby increasing the reaction kinetics and resulting in rapid analysis. These criteria, combined with their suitability for multiplex analysis and real-time monitoring (Wang et al., Anal. Chem. 83:3528 (2011)), make microfluidics-enabled devices particularly powerful.

An arrayable and self-labelled DNA detection system on a planar Au surface has been reported previously (Du et al., J. Am. Chem. Soc. 125:4012 (2003); Strohsahl et al., Nat. Protoc. 2:2105 (2007); Du et al., J. Am. Chem. Soc. 127:7932 (2005)). In the absence of target DNA, a fluorophore-labelled (3′) and metal surface-immobilized DNA probe folds itself into a hairpin structure, concomitantly placing its attached fluorophore in close proximity to the metal surface. This results in fluorescence quenching. When a complementary target DNA is present, hybridization to the surface-immobilized probe DNA unfolds the hairpin, in turn moving the fluorophore away from the metal surface, preventing quenching and thereby signaling the presence of the specific target DNA through a fluorescence intensity increase. When combined with methods for the identification of “natural” hairpin probes, this strategy can produce a sensor with exceptionally high selectivity (Strohsahl et al., Biosens. Bioelectron. 23:233 (2007)).

It was later demonstrated that Ag nanoparticles on the substrate surface can dramatically amplify signals via metal-enhanced fluorescence (MEF) (Zhang et al., Nano Lett. 7:2101 (2007)) and significantly enhance sensor performance (Peng et al., ACS Nano 3:2265 (2009)). In response to identical amounts of target DNA, Ag nanoparticle-structured substrates provide post-hybridization sensor signals over 10-fold higher than the responses from planar Au films. As strong signals could be obtained from substrates functionalized at low Ag nanoparticle density, the transparent nature of these DNA chips (potentially allowing imaging either above the chip or through it with equal facility) was tailor-made for implementation in a microfluidic system.

However, substrate masking to limit nanoparticle deposition to the fluid channels and removal of the mask to allow for direct bonding of the channel-defining polymer structures to the substrate are expensive and time consuming steps. It would be desirable, therefore, to identify alternative fabrication processes that can avoid these additional steps while affording a micro fluidic device that still allows for post-hybridization signal enhancement contributed by the metal nanoparticle-structured substrate.

The present invention is directed to overcoming these and other deficiencies in the art.

### SUMMARY OF THE INVENTION

A first aspect of the present invention relates to a microfluidic device that includes a substrate having a surface covered by a discontinuous metal nanoparticle layer; a nucleic acid molecule tethered to the metal nanoparticle layer; and a polymer coating adhered to or covalently bound the surface of the substrate, the polymer coating and substrate together defining one or more channels having an inlet and an outlet, whereby the nucleic acid molecule is present within the one or more channels.

According to one embodiment, the nucleic acid molecule is characterized by being able to (i) self-anneal into a hairpin conformation and (ii) hybridize specifically to a target nucleic acid molecule, the nucleic acid molecule having first and second ends, where the first end is tethered to the metal nanoparticle layer and the second end is bound by a fluorophore, whereby when the nucleic acid molecule is in the hairpin conformation, the metal nanoparticle layer substantially quenches fluorescent emissions by the fluorophore, and when the nucleic acid molecule is in a non-hairpin conformation (i.e., bound by its target nucleic acid molecule) fluorescent emissions by the fluorophore are surface plasmon-enhanced.

A second aspect of the invention relates to a biological sensor device that includes a microfluidic device according to the first aspect of the invention, a light source that illuminates the substrate at a wavelength suitable to induce fluorescent emissions by the fluorophore(s); and a detector positioned to detect fluorescent emissions by the fluorophore(s).

A third aspect of the invention relates to a method of detecting the presence of a target nucleic acid molecule in a sample. This method includes the steps of: passing an aqueous solution through the one or more channels of the micro fluidic device according to the first aspect of the invention under conditions effective to allow any target nucleic acid molecule in the sample to hybridize to the nucleic acid molecules, causing the nucleic acid molecules to adopt the non-hairpin conformation; illuminating the micro fluidic device with light sufficient to cause emission of fluorescence by the fluorophore(s); and determining whether or not the microfluidic device emits fluorescent emissions of the fluorophore(s) upon said illuminating, wherein fluorescent emission by the fluorophore(s) indicates that a nucleic acid molecule is in the non-hairpin conformation and therefore that its target nucleic acid molecule is present in the sample.

A fourth aspect of the invention relates to a method of making a microfluidic device. This method includes the steps of: providing a substrate with a surface thereof coated with metal nanoparticles to form a discontinuous metal nanoparticle layer and one or more nucleic acid molecules covalently attached to the discontinuous metal nanoparticle layer; and attaching a polymer coating to the substrate, whereby the polymer coating and substrate surface together define one or more channels having an inlet and an outlet.

In one embodiment, the one or more nucleic acid molecules are different from one another and characterized by being able to (i) self-anneal into a hairpin conformation and (ii) hybridize specifically to a target nucleic acid molecule, each of the plurality of nucleic acid molecules having first and second ends, which first end is attached to the metal nanoparticle layer and which second end is bound to a fluorophore.

The present invention affords self-labeled nucleic acid detection systems that are capable of achieving a dramatic fluorescence enhancement over detection systems that utilize a planar metal quenching surface. It has been shown previously that the surface topography of the quenching nanoparticle substrate and the amount of metal nanoparticles deposited onto the surface can be varied by controlling the exposure time in a constant concentration of metal salt solution. Furthermore, detection performance and signals were dependent on both the surface topography/NP coverage and the distance between the fluorophore and the nanoparticle-coated substrate surface. These findings collectively indicated the importance of local probe density adjustment and probe length selection for optimal detection performance. The ability to pattern the probe immobilization on the surface by controlling the spacing between nanoparticles can avoid or minimize the need for spacer molecules that are required for optimal performance on solid Au surfaces. Of further interest is the fact that the low-exposure nanoparticle substrates are transparent, which allow for their inclusion in a flow-through device in which either imaging or illumination occurs from the opposite face rather than the functionalized face that is exposed to the sample. Importantly, the Examples demonstrate that an oxide (glass) surface that is structured with a discontinuous metal nanoparticle layer over substantially its entire surface can be covalently bound with a polymer coating (e.g., polydimethylsiloxane or PDMS) to form a microfluidic channel. This simplifies device construction because masking (and then mask removal) is not required to restrict application of the discontinuous layer of metal nanoparticles to only those regions that define the microfluid channels.

### BRIEF DESCRIPTION OF THE DRAWINGS

FIG. 1 illustrates the working principle of the plasmonic-enabled DNA biosensor. In step (A), a DNA probe, immobilized on a metal nanoparticle-coated surface, folds itself into a hairpin structure in the absence of a target DNA. This in turn brings the probe-attached fluorophore in close proximity to the nanoparticle-coated surface and quenches the fluorescence due to energy transfer (designated RET). In step (B), a sample containing a complementary target DNA is added to the biosensor. In step (C), the target DNA hybridizes with its complementary DNA hairpin probe, unwraps the DNA hairpin probe, and liberates the fluorophore from the quenching surface to the fluorescence enhancing zone nearby the nanoparticles, signalling the presence of a specific DNA sequence.

FIG. 2 is a schematic of the simple microfluidic device. The polymer layer that defines the microchannel is covalently bonded to a metal nanoparticle-covered glass surface carrying an array of DNA hairpin probe spots (represented by circles). Spot size, number of spots, and channel dimensions are not drawn to scale. Although only a single arrangement (row) of spots is shown, it should be appreciated that depending on channel dimensions, an array of spots can be formed across the width and length of the channel.

FIG. 3 illustrates schematically an exemplary biological sensor that includes the microfluidic device of the invention.

FIG. 4 shows a process for channel-embedded PDMS replicate fabrication. In the first step, a photoresist mold containing a negative image (raised feature) of the microchannel is provided. In the second step, an activated PDMS mixture is poured on the photoresist mold and then cured. In the final step, the cured PDMS film is peeled away from the mold.

FIG. 5 illustrates assembly of the channel-embedded PDMS replicate and nanostructured metal substrate assembly. In the first step, a previously UV-ozone treated channel-embedded PDMS replicate that was drilled with an inlet and outlet is first placed against the metal nanoparticle-coated substrate facing down. In the second step, compressive pressure is applied to the PDMS-substrate device until thoroughly bonded. In the final step, inlet and outlet tubing are inserted into the inlet and outlet pores of the channel, respectively.

FIG. 6 shows a schematic illustration of a multiplex array on an Ag-nanoparticle coated glass substrate. Two columns of spots were printed on the Ag-nanoparticle coated glass substrate. The first column comprised 10 spots of the Enterbact3a probe (SEQ ID NO: 3) and the second column comprised 10 spots of the Eco3a probe (SEQ ID NO: 2). The schematic illustration is not drawn in scale.

FIGS. 7A-B illustrate fluorescence microarray images showing DNA hairpin probe spots on the channel floor under fluid flow. FIG. 7A was obtained under a 10× objective using a CCD exposure time of 10 s. FIG. 7B was obtained under a 4× objective using a CCD exposure time of 20 s. Dotted lines in FIG. 7B illustrate the location of channel walls. Scale bar: 250 μm.

FIGS. 8A-B shows fluorescence microarray images showing the signals from four identical Bacillus anthracis probe (SEQ ID NO: 1) spots on the channel floor before (FIG. 8A) and after (FIG. 8B) exposure to a 2.5 μM target solution that was introduced into the channel at a velocity of 0.5 μl/min for 30 min. Scale bar: 250 μm. CCD exposure time was 10 s.

FIG. 9 is a graph showing real-time detection responses versus target flowing time. Target concentration: 500 nM. A 10× objective and a CCD exposure time of 10 s was used for all measurements. Baseline signal (Ipre) is on the order of 15000 a.u. and the background signals (blank without DNA probes) is on the order of 10000 a.u.

FIG. 10 shows real-time fluorescence intensity changes as a function of different target DNA concentrations. Data are presented as mean±standard deviation. N=3 (3 microfluidic channels) for each target concentration. CCD exposure time was 10 s.

FIG. 11 shows fluorescence intensity changes as a function of different target DNA concentrations. Compared to FIG. 10, the target DNA concentrations were lower (25 nM, 5 nM, 500 pM, and 0 M target). Data are presented as mean±standard deviation. N=3 (3 microfluidic channels) for each target concentration. CCD exposure time was 10 s. Statistical analysis was performed using one-way ANOVA with tukey post hoc test, Matlab. (*) Significant difference was found for each group from all other groups.

FIG. 12 shows a dose response plot from lower concentration target analyte solutions used in FIG. 11 (500 pM, 5 nM, and 25 nM). Detection responses after 2 h of target delivery from each group are plotted against the target concentrations. Data are presented as mean±standard deviation. N=3 (3 substrates). The dotted line and the 3σ gray areas represent the mean and 3 standard deviations of the negative control (buffer only), respectively.

FIG. 13 shows real-time fluorescence responses during a continuous target solution flow for a multiplex sensor arrayed with Enterbact3a and Eco3a probes (illustrated in FIG. 6). The 500 nM synthetic Enterbact3a target DNA solution was delivered to the device at a speed of 0.5 μl/min for 30 min. Data are presented as mean±standard deviation. N=3 (3 microfluidic channels). CCD exposure time: 10 s.

FIG. 14 illustrates fluorescence intensity changes from microfluidic channels upon introduction of buffer only into the same multiplex sensor used for FIG. 13 at a velocity of 0.5 μl/min for 30 min. Data are presented as mean±standard deviation. N=3 (3 microfluidic channels).

### DETAILED DESCRIPTION OF THE INVENTION

The present invention relates to a micro fluidic device that utilizes nucleic acid-based detection and a detection system containing the microfluidic device, as well as a process for preparing the micro fluidic device and for using the same to detect the presence of a target nucleic acid molecule in a sample.

According to a first aspect of the invention, a microfluidic device includes a substrate having a surface covered by a discontinuous metal nanoparticle layer; a nucleic acid molecule tethered to the metal nanoparticle layer; and a polymer coating adhered to or covalently bound the surface of the substrate, the polymer coating and substrate together defining one or more channels having an inlet and an outlet, whereby the nucleic acid molecule is present within the one or more channels.

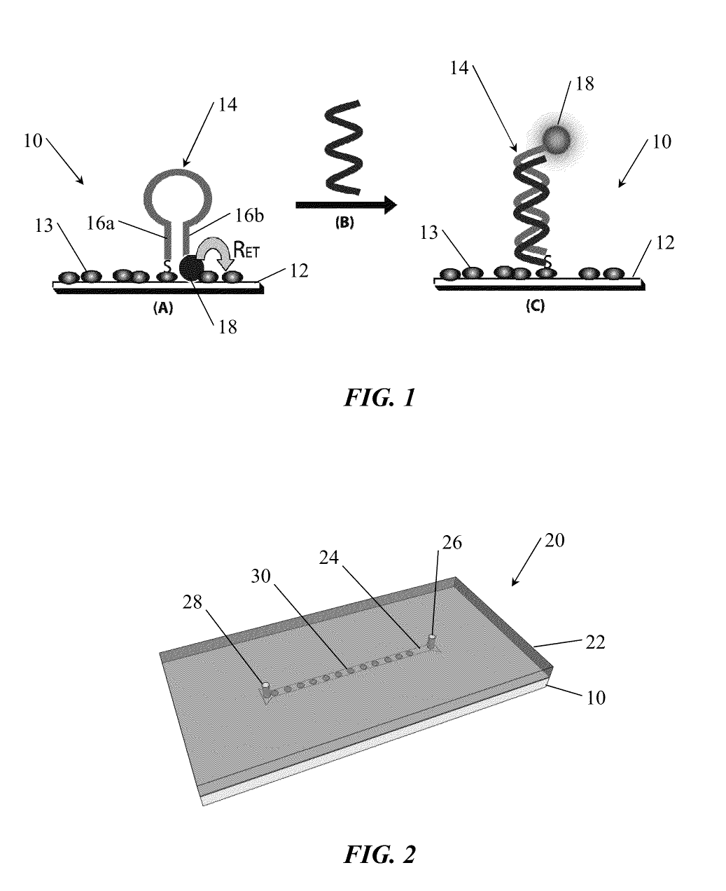

As shown in FIG. 1, the substrate 10 has a surface 12 that is covered by a discontinuous metal nanoparticle layer comprised of nanoparticles 13; one or more nucleic acid molecules 14 (i.e., as probes) each having first and second ends with the first end bound to the metal nanoparticle layer (i.e., a metal nanoparticle of that layer), a first region 16a, and a second region 16b complementary to the first region; and a fluorophore 18 bound to the second end of the nucleic acid molecule 14. As illustrated in step (A), when the nucleic acid molecule 14 is in a hairpin configuration, fluorescence by the fluorophore is quenched (RET) by the metal nanoparticles that are in close proximity to the fluorophore. However, upon introduction of a sample (B) containing a complementary target nucleic acid molecule, the target upon hybridizing to the nucleic acid molecule 14 at step (C) will disrupt the self-annealed hairpin configuration and allow fluorescence of the fluorophore to be emitted. This fluorescence is plasmon-enhanced by the metal nanoparticle layer.

Suitable nucleic acid probes can be DNA, RNA, or PNA. The nucleic acid probes of the present invention can also possess one or more modified bases, one or more modified sugars, one or more modified backbones, or combinations thereof. The modified bases, sugars, or backbones can be used either to enhance the affinity of the probe to a target nucleic acid molecule or to allow for binding to the metal nanoparticle layer as described hereinafter. Exemplary forms of modified bases are known in the art and include, without limitation, alkylated bases, alkynylated bases, thiouridine, and G-clamp (Flanagan et al., Proc. Natl. Acad. Sci. USA 30:3513-3518 (1999), which is hereby incorporated by reference in its entirety). Exemplary forms of modified sugars are known in the art and include, without limitation, LNA, 2′-O-methyl, 2′-O-methoxyethyl, and 2′-fluoro (see, e.g., Freier and Attmann, Nucl. Acids Res. 25:4429-4443 (1997), which is hereby incorporated by reference in its entirety). Exemplary forms of modified backbones are known in the art and include, without limitation, phosphoramidates, thiophosphoramidates, and alkylphosphonates. Other modified bases, sugars, and/or backbones can, of course, be utilized.

With the first and second regions 16a,16b of the nucleic acid molecules 14 being complementary to one another, the nucleic acid probes have, under appropriate conditions, either (i) a hairpin conformation with the first and second regions hybridized together (shown at step (A) of FIG. 1) or (ii) a non-hairpin conformation (shown at step (C) of FIG. 1). The conditions under which the hairpin conformation exists is when the nucleic acid probe is maintained below its melting temperature (i.e., considering the length of the first and second regions, the GC content of those regions, and salt concentration), and typically when the target nucleic acid is not present. The conditions under which the non-hairpin conformation exists are either when the first nucleic acid is maintained above its melting temperature and/or when the probe is hybridized to its target nucleic acid (as shown in FIG. 1).

The overall length of the nucleic acid probe is preferably between about 12 and about 60 nucleotides. The probe length is more preferably between about 20 and about 50 nucleotides or between about 25 and about 45 nucleotides, most preferably between about 30 and about 40 nucleotides. It should be appreciated, however, that longer or shorter nucleic acids can certainly be used. The first and second regions of the nucleic acid probes are preferably at least about 4 nucleotides in length, more preferably at least about 5 nucleotides in length or at least about 6 nucleotides in length. In the preferred embodiments described above, the first and second regions can be up to about 28 nucleotides in length, depending on the overall length of the nucleic acid probe and the size of a loop region present between the first and second regions. It is believed that a loop region is needed to allow the hairpin to form, and the loop region preferably contains at least about 4 or 5 nucleotides. The first and second regions can be perfectly matched (i.e., having 100 percent complementary sequences that form a perfect stem structure of the hairpin conformation) or less than perfectly matched (i.e., having non-complementary portions that form bulges within a non-perfect stem structure of the hairpin conformation). When the first and second regions are not perfectly matched the first and second regions can be the same length or they can be different in length, although they should still have at least 4 complementary nucleotides.

Nucleic acid probes of the present invention can have their entire length or any portion thereof targeted to hybridize to the target nucleic acid molecule, which can be RNA or DNA. Thus, the entire probe can hybridize to a target sequence of the target nucleic acid molecule or, alternatively, a portion thereof can hybridize to a target sequence of the target nucleic acid molecule. When less than the entire nucleic acid probe is intended to hybridize to the target nucleic acid molecule, the portion thereof that does hybridize (to the target nucleic acid molecule) should be at least about 50 percent, preferably at least about 60 or 70 percent, more preferably at least about 80 or 90 percent, and most preferably at least about 95 percent of the nucleic acid probe length. When only a portion of the nucleic acid probe is intended to hybridize to the target nucleic acid molecule, that portion can be part of the first region, part of the second region, or spanning both the first and second regions. As used herein to describe the portion of the probe that hybridizes to a target nucleic acid, the phrase “substantially the entire length thereof” is intended to mean not more than two probe nucleotides, preferably not more than one probe nucleotide, that do not hybridize to the target over the length of the probe.

A number of preferred hairpin probes are identified in co-pending U.S. Patent Application Publ. No. 20070059693 and U.S. patent application Ser. No. 11/838,616 to Miller et al., each of which is hereby incorporated by reference in its entirety.

Selection of suitable nucleic acid molecules for use as probes can be achieved by (i) identifying an oligonucleotide that can hybridize to the target nucleic acid and then designing a nucleic acid probe that includes the oligonucleotide as a component part of the first and/or second region, and optionally as a component part of any loop region between the first and second regions; (ii) by identifying naturally occurring hairpin structures within the predicted folding structure of a target nucleic acid molecule, as described in co-pending PCT Publ. No. WO 2005/104813 and U.S. Pat. No. 7,442,510, both to Miller et al., each of which is hereby incorporated by reference in its entirety; or (iii) using a combination of the above procedures, modifying a portion of a naturally occurring hairpin structure, e.g., modifying one or more bases in the first or second region to increase the stability of the resulting probe or the stability of the probe-target interaction.

Referring again to FIG. 1, while the probe remains in the hairpin conformation the fluorophore 18 bound to the second end of the nucleic acid probe is brought into sufficiently close proximity to the metal nanoparticle layer such that the metal nanoparticle layer substantially quenches fluorescent emissions by the fluorophore. As discussed hereinafter, the rate of energy transfer is dependent upon the distance separating the fluorophore and the metal nanoparticle layer. In contrast, while the probe remains in the non-hairpin conformation, the fluorophore 18 bound to the second end of the nucleic acid probe is no longer constrained in proximity to the metal nanoparticle layer. As a result of its physical displacement away from the metal nanoparticle layer, fluorescent emissions by the fluorophore 18 are substantially free of any quenching and, instead, the fluorescent emissions of the fluorophore are surface plasmon enhanced. This results in an order of magnitude gain in fluorescent intensity, allowing for reliable detection of small quantities of target nucleic acid.

Local surface plasmon resonance (LSPR) is a phenomenon caused by resonant light excitation of a collective electron oscillation in a metal particle, called a surface plasmon. For noble metals, the damping of this oscillation (proportional to the imaginary component of the metal dielectric constant) is very weak leading to giant electric field strengths near the particle surface (Moskovits, Rev. Mod. Phys., 57:783-826 (1985); Yang et al., J. Chem. Phys., 103:869-875 (1995), each of which is hereby incorporated by reference in its entirety). These scattered electric fields can couple strongly to radiative modes of local transition dipoles, thereby creating a significant enhancement of over 15 orders of magnitude in certain optical properties such as Raman scattering of adsorbed molecules (Nie et al., Science 275:1102-1106 (1997); Michaels et al., J. Am. Chem. Soc. 121:9932-9939 (1999); Pan et al., J. Phys. Chem. B 110:17383-17387 (2006); Wang et al., Proc. Natl. Acad. Sci. USA 100:8638-8643 (2003), each of which is hereby incorporated by reference in its entirety).

Nonradiative energy transfer from a photoexcited dye molecule to the metal causes fluorescence quenching of the dye, and this effect is precisely why the metal-immobilized fluorophore-functionalized DNA hairpin device does not fluoresce appreciably when the dye molecule is maintained in close proximity to the metal nanoparticle layer (i.e., in absence of complementary DNA). Fluorescence quenching on gold surfaces was also recently observed for CdSe NCs (Shimizu et al., Phys. Rev. Lett. 89:117401-117404 (2002), which is hereby incorporated by reference in its entirety). For a noble metal nanoparticle (as opposed to a planar surface), energy transfer is still fast enough to suppress fluorescence from single surface bound dye molecules (Nie et al., Science 275:1102-1106 (1997); Michaels et al., J. Am. Chem. Soc. 121:9932-9939 (1999); Pan et al., J. Phys. Chem. B 110:17383-17387 (2006); Wang et al., Proc. Natl. Acad. Sci. USA 100:8638-8643 (2003), each of which is hereby incorporated by reference in its entirety). However, upon displacement of only a nanometer or two from the surface, coupling between molecular and metallic electronic levels is inefficient and quenching of fluorescence no longer occurs. With respect to immobilized hairpin DNA probes, upon target recognition the fluorophore is displaced by on the order of 5-10 nm depending on the length of the oligonucleotide probe (3.4 nm per 10 base pairs). This short distance places the dye directly in the giant electric field region arising from the local surface plasmon of the nanoparticle, which should greatly enhance absorption and fluorescence of the dye molecule. Further enhancements are possible through abrupt shape features that produce enhanced electric fields through a lightening rod effect (Gersten et al., J. Chem. Phys. 73:3023-3037 (1980), which is hereby incorporated by reference in its entirety). Thus, using surfaces tailored to exhibit a large LSPR effect, it is expected that increases of several orders of magnitude are possible for the signal from the molecular beacon array.

The metal nanoparticle layer on substrate 12 is capable of quenching or absorbing the fluorescent emissions of the fluorophore within the desired bandwidth. The metal nanoparticle layer is present as a discontinuous film applied to (i.e., covering) substantially the entire surface of the substrate. By “substantially the entire surface” it is understood that the nanoparticles only cover a portion of the total surface area of the substrate, and some regions of the substrate may lack nanoparticles. In terms of the process used to apply (and/or covalently bond) the nanoparticles to the surface, it is intended that the application is performed without any masking of the substrate surface “Substantially entirely covering” or “substantially entirely covered” may be used synonymously with “substantially the entire surface”. As a consequence, the surface of the substrate remains partially exposed, i.e., in between those locations where the nanoparticles are bound. The substrate is preferably light transmissive, and it can be formed of a non-quenching material such as an oxide glass or polymer, e.g., PDMS, or a quenching material such as a different metal than that used to form the metal nanoparticle layer.

As described below, a number of approaches exist for applying the metal nanoparticle layer onto substrate 12.

One approach involves precipitation of Ag using the Tollens silver mirror reaction. To facilitate binding between the silver mirror and the substrate, the substrate is preferably cleaned and washed, and then coated with a thin chromium layer via vapor deposition (see Du et al., J. Am. Chem. Soc. 127:7932-40 (2005), which is hereby incorporated by reference in its entirety). Thereafter, KOH can be used to precipitate AgNO₃ and then dropwise introduction of 15 M concentrated ammonium hydroxide redissolves the precipitate via formation of [Ag(NH₃)₂]⁺. Glass substrate left in this solution for several minutes up to about an hour will then be treated with dextrose (added to a concentration of about 0.25 M). Device performance is strongly dependent on the amount of Ag present on the surface. Attachment of thiolated hairpins to the silver surface can be carried out according to known procedures (e.g., U.S. Patent Publ. No. 20070059693 to Miller et al. and U.S. patent application Ser. No. 11/838,616 to Miller et al., each of which is hereby incorporated by reference in its entirety).

According to a second approach, glass substrate can be silanized according to known procedures (e.g., 1% 3-mercaptopropryltrimethoxy silane (MPTS) in 95% methanol acidified with 1 mM acetic acid for 30 minutes). Following silanization and cleaning, slides can be coated with silver nanoparticles using a protocol based on that described by Sabanayagam et al., Nucleic Acids Res. 35(2):e13 (2007), which is hereby incorporated by reference in its entirety). The silanized glass slides can be incubated overnight (up to ˜18 hrs) in a solution of AgNO₃ dissolved to a concentration of 10 mM in anhydrous or hydrous N,N-dimethylformamide (DMF). Using 10 mM AgNO₃ solution, optimal Ag nanoparticle film deposition can be achieved in about 20 to about 60 minutes.

According to a third approach, nanosphere lithography (NSL) can be employed (Hulteen et al., J. Phys. Chem. B 103:3854-3863 (1999); Haynes et al., J. Phys. Chem. B 105:5599-5611 (2001), each of which is hereby incorporated by reference in its entirety). Briefly, 5 μl of carboxyl terminated polystyrene nanospheres (Interfacial Dynamics Corporation) with a desired diameter (up to several hundred nm in diameter) can be drop cast onto a glass substrate and then slow evaporation of the water will cause the nanospheres to self assemble into a hexagonally close packed monolayer. The nanosphere monolayer acts as a mask for deposition of evaporated silver or gold. Subsequent sonication in ethanol removes the spheres and leaves behind an array of uniformly spaced, triangularly shaped metal nanoparticles (Haynes et al., J. Phys. Chem. B, 105, 5599-5611 (2001), which is hereby incorporated by reference in its entirety). Smaller nanospheres can reduce the dimension of the nanoparticle deposits and also reduce the spacing between them, whereas larger nanospheres can increase the dimension of the nanoparticle deposits and also increase the spacing between them.

Although the above-described approaches describe the use of silver nanoparticles, it should be appreciated that other metal nanoparticles can similarly be deposited onto the substrate surface. Preferred materials for formation of the metal nanoparticle layer include conductive metals or metal alloys, which offer the ability to completely or nearly completely quench the fluorescence emissions of the fluorophore. Suitable conductive metals or metal alloys include, without limitation, gold, silver, platinum, titanium, copper, gallium, aluminum, p-doped silicon (e.g., (CH₃)₂Zn, (C₂H₅)₂Zn, (C₂H₅)₂Be, (CH₃)₂Cd, (C₂H₅)₂Mg, B, Al, Ga, or In dopants), n-doped silicon (e.g., H₂Se, H₂S, CH₃Sn, (C₂H₅)₃S, SiH₄, Si₂H₆, P, As, or Sb dopants), and doped germanium. Of these, gold, silver, and platinum are typically preferred.

According to one preferred embodiment, the substrate is an oxide glass and the metal nanoparticle layer is formed of silver nanoparticles.

According to another preferred embodiment, the substrate includes a substantially planar gold surface coated onto another material (e.g., chromium-coated oxide glass or polymer) and the metal nanoparticle layer is applied to the gold surface.

Regardless of the approach for forming the metal nanoparticle layer, the resulting film should be characterized by fractal roughness that is sufficient to allow both quenching and surface plasmon enhancement of fluorescent emission depending on the configuration of the nucleic acid probe and the proximity of the fluorophore to the metal nanoparticle layer. The metal nanoparticle layer is preferably either transparent or translucent (e.g., having a thickness that is less than about 100 nm, more preferably less than about 80 nm, 70 nm, 60 nm, or 50 nm, and most preferably less than about 40 nm or 30 nm). In certain embodiments, the metal nanoparticle layer is preferably characterized by surface roughness of between about 0.7 nm and about 3 nm, more preferably between about 1 nm and about 2.4 nm, most preferably between about 1 nm and about 2 nm. In certain embodiments, the metal nanoparticle layer includes nanoparticles having a size between about 3 nm and about 30 nm, and an average particle size of about 4.5 to about 9 nm, more preferably about 5 to about 8 nm. In certain embodiments, the metal nanoparticle layer has a particle density of about 300 to about 800 per μm², preferably about 300 to about 750 per μm². In certain embodiments, combinations of these features are present to achieve an R value exceeding about 5, more preferably exceeding and R value of about 6, about 7, about 8, or about 9, most preferably exceeding an R value of about 10, about 11, or about 12.

It was a surprising discovery that a surface that is substantially entirely covered with a discontinuous metal nanoparticle layer can be used to bond covalently with a polymer covering layer such as PDMS to form a microfluidic device with one or more microfluidic channels. It is believed that the discontinuous metal nanoparticle layer allows the substrate surface to remain partially exposed such that a fluid tight bond between the polymer and substrate can be achieved.

Because the metal nanoparticle layer is discontinuous over the surface of the substrate, the surface area coverage by the metal nanoparticle layer is less than 100 percent, preferably less than 80 percent, more preferably less than about 60 percent, less than about 50 percent, less than about 40 percent, or less than about 30 percent. In the accompanying Examples, embodiments of the invention are illustrated where the surface area coverage by the metal nanoparticle layer is about 20 percent. The discontinuous metal nanoparticle layer affords two significant benefits: (1) it surprisingly allows for bonding of a polymer, such as PDMS, to the exposed surface of the substrate; and (2) it allows for optimization of the hairpin density to maximize device sensitivity.

The nucleic acid probe can be bound to the metal nanoparticle layer using known nucleic acid-binding chemistry or by physical means, such as through ionic, covalent or other forces well known in the art (see, e.g., Dattagupta et al., Analytical Biochemistry 177:85-89 (1989); Saiki et al., Proc. Natl. Acad. Sci. USA 86:6230-6234 (1989); Gravitt et al., J. Clin. Micro. 36:3020-3027 (1998), each of which is hereby incorporated by reference in its entirety). Of these approaches, covalent binding is preferred because the sensor chip will be more durable for repeated use. Either a terminal base or another base near the terminal base can be bound to the metal nanoparticle layer. For example, a terminal nucleotide base of the nucleic acid probe can be modified to contain a reactive group, such as (without limitation) carboxyl, amino, hydroxyl, thiol, or the like, thereby allowing for coupling of the nucleic acid probe to the metal nanoparticle layer.

The fluorophore can be any fluorophore capable of being bound to a nucleic acid molecule. Suitable fluorophores include, without limitation, fluorescent dyes, proteins, and semiconductor nanocrystal particles. Of these, dyes are preferred due to their size constraints and the commercial availability of dye-labeled nucleic acid molecules. The fluorophore used in the present invention is characterized by a fluorescent emission maximum that is detectable either visually or using optical detectors of the type known in the art. Fluorophores having fluorescent emission maxima in the visible spectrum are preferred.

Exemplary dyes include, without limitation, Cy2™, YO-PRO™-1, YOYO™-1, Calcein, FITC, Fluor X™, Alexa™, Rhodamine 110, 5-FAM, Oregon Green™ 500, Oregon Green™ 488, RiboGreen™, Rhodamine Green™, Rhodamine 123, Magnesium Green™, Calcium Green™, TO-PRO™-1, TOTO®-1, JOE, BODIPY® 530/550, Dil, BODIPY® TMR, BODIPY® 558/568, BODIPY® 564/570, Cy3™, Alexa™ 546, TRITC, Magnesium Orange™, Phycoerythrin R&B, Rhodamine Phalloidin, Calcium Orange™, Pyronin Y, Rhodamine B, TAMRA, Rhodamine Red™, Cy3.5™, ROX, Calcium Crimson™, Alexa™ 594, Texas Red®, Nile Red, YO-PRO™-3, YOYO™-3, R-phycocyanin, C-Phycocyanin, TO-PRO™-3, TOTO®-3, DiD DilC(5), Cy5™, Thiadicarbocyanine, and Cy5.5™. Other dyes now known or hereafter developed can similarly be used as long as their excitation and emission characteristics are compatible with the light source and non-interfering with other fluorophores that may be present (i.e., not capable of participating in significant fluorescence resonant energy transfer or FRET).

Attachment of dyes to the opposite end of the nucleic acid probe can be carried using any of a variety of known techniques allowing, for example, either a terminal base or another base near the terminal base to be bound to the dye. For example, 3′-tetramethylrhodamine (TAMRA) may be attached using commercially available reagents, such as 3′-TAMRA-CPG, according to manufacturer's instructions (Glen Research, Sterling, Va.). Other exemplary procedures are described in, e.g., Dubertret et al., Nature Biotech. 19:365-370 (2001); Wang et al., J. Am. Chem. Soc., 125:3214-3215 (2003); Bioconjugate Techniques, Hermanson, ed. (Academic Press) (1996), each of which is hereby incorporated by reference in its entirety.

Exemplary proteins include, without limitation, both naturally occurring and modified green fluorescent proteins (Prasher et al., Gene 111:229-233 (1992); PCT Application WO 95/07463, each of which is hereby incorporated by reference in its entirety) from various sources such as Aequorea and Renilla; both naturally occurring and modified blue fluorescent proteins (Karatani et al., Photochem. Photobiol. 55(2):293-299 (1992); Lee et al., Methods Enzymol. (Biolumin. Chemilumin) 57:226-234 (1978); Gast et al., Biochem. Biophys. Res. Commun. 80(1):14-21 (1978), each of which is hereby incorporated by reference in its entirety) from various sources such as Vibrio and Photobacterium; and phycobiliproteins of the type derived from cyanobacteria and eukaryotic algae (Apt et al., J. Mol. Biol. 238:79-96 (1995); Glazer, Ann. Rev. Microbiol. 36:173-198 (1982); Fairchild et al., J. Biol. Chem. 269:8686-8694 (1994); Pilot et al., Proc. Natl. Acad. Sci. USA 81:6983-6987 (1984); Lui et al., Plant Physiol. 103:293-294 (1993); Houmard et al., J. Bacteriol. 170:5512-5521 (1988), each of which is hereby incorporated by reference in its entirety), several of which are commercially available from ProZyme, Inc. (San Leandro, Calif.). Other fluorescent proteins now known or hereafter developed can similarly be used as long as their excitation and emission characteristics are compatible with the light source and non-interfering with other fluorophores that may be present.

Attachment of fluorescent proteins to the opposite end of the nucleic acid probe can be carried using any of a variety of known techniques, for example, either a terminal base or another base near the terminal base can be bound to the fluorescent protein. Procedures used for tether dyes to the nucleic acid can likewise be used to tether the fluorescent protein thereto. These procedures are generally described in, e.g., Bioconjugate Techniques, Hermanson, ed. (Academic Press) (1996), which is hereby incorporated by reference in its entirety.

Nanocrystal particles or semiconductor nanocrystals (also known as Quantum Dot™ particles), whose radii are smaller than the bulk exciton Bohr radius, constitute a class of materials intermediate between molecular and bulk forms of matter. Quantum confinement of both the electron and hole in all three dimensions leads to an increase in the effective band gap of the material with decreasing crystallite size. Consequently, both the optical absorption and emission of semiconductor nanocrystals shift to the blue (higher energies) as the size of the nanocrystals gets smaller.

The core of the nanocrystal particles is substantially monodisperse. By monodisperse, it is meant a colloidal system in which the suspended particles have substantially identical size and shape, i.e., deviating less than about 10% in rms diameter in the core, and preferably less than about 5% in the core.

Particle size can be between about 1 nm and about 1000 nm in diameter, preferably between about 2 nm and about 50 nm, more preferably about 5 nm to about 20 nm (such as about 5, 6, 7, 8, 9, 10, 11, 12, 13, 14, 15, 16, 17, 18, 19, or 20 nm).

When capped nanocrystal particles are illuminated with a primary light source, a secondary emission of light occurs of a frequency that corresponds to the band gap of the semiconductor material used in the nanocrystal particles. The band gap is a function of the size of the nanocrystal particle. As a result of the narrow size distribution of the capped nanocrystal particles, the illuminated nanocrystal particles emit light of a narrow spectral range resulting in high purity light. Spectral emissions in a narrow range of no greater than about 60 nm, preferably no greater than about 40 nm and most preferably no greater than about 30 nm at full width half max (FWHM) are observed. Spectral emissions in even narrower ranges are most preferred.

The nanocrystal particles are preferably passivated or capped either with organic or inorganic passivating agents to eliminate energy levels at the surface of the crystalline material that lie within the energetically forbidden gap of the bulk interior. These surface energy states act as traps for electrons and holes that would normally degrade the luminescence properties of the material. Such passivation produces an atomically abrupt increase in the chemical potential at the interface of the semiconductor and passivating layer (Alivisatos, J. Phys. Chem. 100:13226 (1996), which is hereby incorporated by reference in its entirety). As a result, higher quantum efficiencies can be achieved.

Exemplary capping agents include organic moieties such as tri-n-octyl phosphine (TOP) and tri-n-octyl phosphine oxide (TOPO) (Murray et al., J. Am. Chem. Soc. 115:8706 (1993); Kuno et al., J. Phys. Chem. 106(23):9869 (1997), each of which is hereby incorporated by reference in its entirety), as well as inorganic moieties such as CdS-capped CdSe and the inverse structure (Than et al., J. Phys. Chem. 100:8927 (1996), which is hereby incorporated by reference in its entirety), ZnS grown on CdS (Youn et al., J. Phys. Chem. 92:6320 (1988), which is hereby incorporated by reference in its entirety), ZnS on CdSe and the inverse structure (Kortan et al., J. Am. Chem. Soc. 112:1327 (1990); Hines et al., J. Phys. Chem. 100:468 (1996), each of which is hereby incorporated by reference in its entirety), ZnSe-capped CdSe nanocrystals (Danek et al., Chem. Materials 8:173 (1996), which is hereby incorporated by reference in its entirety), and SiO₂ on Si (Wilson et al., Science 262:1242 (1993), which is hereby incorporated by reference in its entirety).

In general, particles passivated with an inorganic coating are more robust than organically passivated particles and have greater tolerance to processing conditions used for their incorporation into devices. Particles that include a “core” of one or more first semiconductor materials can be surrounded by a “shell” of a second semiconductor material.

Thus, the nanocrystal particles as used in the present invention can be formed of one or more semiconducting materials. Suitable semiconducting materials include, without limitation, a group IV material alone (e.g., Si and Ge), a combination of a group IV material and a group VI material, a combination of a group III material and a group V material, or a group II material and a group VI material. When a combination of materials is used, the semiconducting materials are presented in a “core/shell” arrangement.

Suitable core/shell material combinations include, without limitation, group IV material forming the core and group VI materials forming the shell; group III material forming the core and group V materials forming the shell; and group II material forming the core and group VI materials forming the shell. Exemplary core/shell combinations for groups IV/VI are: Pb and one or more of S, Se, and Te. Exemplary core/shell combinations for groups III/N are: one or more of Ga, In, and Al as the group III material and one or more of N, P, As, and Sb as the group V material. Exemplary core/shell combinations for groups II/VI are: one or more of Cd, Zn, and Hg as the group II material, and one or more of S, Se, and Te as the group VI material. Other combinations now known or hereinafter developed can also be used in the present invention.

Fluorescent emissions of the resulting nanocrystal particles can be controlled based on the selection of materials and controlling the size distribution of the particles. For example, ZnSe and ZnS particles exhibit fluorescent emission in the blue or ultraviolet range (˜400 nm or less); CdSe, CdS, and CdTe exhibit fluorescent emission in the visible spectrum (between about 440 and about 700 nm); InAs and GaAs exhibit fluorescent emission in the near infrared range (˜1000 nm), and PbS, PbSe, and PbTe exhibit fluorescent emission in the near infrared range (i.e., between about 700-2500 nm). By controlling growth of the nanocrystal particles it is possible to produce particles that will fluoresce at desired wavelengths. As noted above, smaller particles will afford a shift to the blue (higher energies) as compared to larger particles of the same material(s).

Preparation of the nanocrystal particles can be carried out according to known procedures, e.g., Murray et al., MRS Bulletin 26(12):985-991 (2001); Murray et al., IBM J. Res. Dev. 45(1):47-56 (2001); Sun et al., J. Appl. Phys. 85(8, Pt. 2A): 4325-4330 (1999); Peng et al., J. Am. Chem. Soc. 124(13):3343-3353 (2002); Peng et al., J. Am. Chem. Soc. 124(9):2049-2055 (2002); Qu et al., Nano Lett. 1(6):333-337 (2001); Peng et al., Nature 404(6773):59-61 (2000); Talapin et al., J. Am. Chem. Soc. 124(20):5782-5790 (2002); Shevenko et al., Advanced Materials 14(4):287-290 (2002); Talapin et al., Colloids and Surfaces, A: Physiochemical and Engineering Aspects 202(2-3):145-154 (2002); Talapin et al., Nano Lett. 1(4):207-211 (2001), each of which is hereby incorporated by reference in its entirety.

Attachment of a nanocrystal particle to the opposite end of the nucleic acid probe can be carried out using any of a variety of known techniques, for example, either a terminal base or another base near the terminal base can be bound to the nanocrystal particle. Procedures used for tethering dyes to the nucleic acid can likewise be used to tether the nanocrystal particle thereto. Details on these procedures are described in, e.g., Bioconjugate Techniques, Hermanson, ed. (Academic Press) (1996), which is hereby incorporated by reference in its entirety.

Having identified the sequence of a nucleic acid molecule to be used as a probe in a sensor of the present invention, and having selected the appropriate fluorophore and metal nanoparticle layer to be utilized, the sensor of the present invention can be assembled using the above-described procedures. Attachment of the fluorophore to one end of the nucleic acid probe can be carried out prior to attachment of the opposite end of the nucleic acid probe to the metal nanoparticle layer, or vice versa. Alternatively, the probe can be ordered from any one of various vendors that specialize in preparing oligonucleotides to desired specifications (i.e., having one end modified for binding to the metal nanoparticle layer and the other end bound by a fluorophore) and thereafter attached to the metal nanoparticle layer. Two exemplary vendors are Midland Certified Reagent Co. (Midland, Tex.) and Integrated DNA Technologies, Inc. (Coralville, Iowa).

In preparing the substrate for nucleic acid attachment to the metal nanoparticle layer, a competitor (or spacer) molecule can also be attached to the metal nanoparticle layer, either as a separate step or as a single step (i.e., using a solution containing both the nucleic acid probe and the competitor molecule). The role of the competitor molecule is simply to minimize the concentration (and promote dispersion) of nucleic acid probes bound to the metal nanoparticle layer, thereby inhibiting the likelihood of interference between adjacent nucleic acid probes, which could result in background fluorescence. It can also help to inhibit non-specific interaction between the nucleic acid probe and the metal nanoparticles layer. Depending on the nature of the metal nanoparticle layer, the competitor molecule may not be needed to optimize performance of the sensor device. Use of competitor molecules for some but not all of the spots on a sensor array is also contemplated; this can be used to optimize similar probe loading at each of the spots on the array. Like the nucleic acid probes, the competitor molecule contains a reactive group such as (without limitation) carboxyl, amino, hydroxyl, thiol, or the like, thereby allowing for coupling of the competitor molecule to the metal nanoparticle layer. Preferred competitor molecules include, without limitation, thiol-containing compounds, such as mercaptopropanol, cysteine, thiooctic acid, 2-mercaptoethanol, 3-mercapto-2-butanol, 2-mercapto, 1,2-propanediol, 2-(butylamino)ethanethiol, 2-dimethylaminoethanethiol, 2-diethylaminoethanethiol, 3-mercaptopropionic acid, etc.

According to one approach, the metal nanoparticle layer is first exposed to a solution containing the competitor molecule and allowed to self-assemble (to the surface) for a sufficient length of time. Thereafter, the modified nanoparticle layer is secondly exposed to a solution containing the nucleic acid probe and allowed to self-assemble (to the surface) for a sufficient length of time. As is well known in the art, the exposure time to one or both of the solutions can vary according to the concentrations of the competitor molecule and the nucleic acid probe in their respective solutions. After each exposure, the metal nanoparticle layer can be rinsed with pure water or saline solution, preferably at elevated temperatures so as to remove unbound competitor or unbound nucleic acid probe, respectively.

According to another approach, the metal nanoparticle layer is simultaneously exposed to a solution containing both the competitor molecule and the nucleic acid probe, and allowed to self-assemble for a sufficient length of time. As noted above, the exposure time to the combined solution can vary according to the concentrations of the competitor molecule and the nucleic acid probe. After exposure, the metal nanoparticle layer can be briefly rinsed with pure water or saline solution, preferably at elevated temperatures so as to remove unbound competitor and/or unbound nucleic acid probe. The resulting sensor chip can then be used to detect the presence of target nucleic acid molecules in sample preparations.

The ratio of the competitor molecule to the nucleic acid probe is preferably greater than 1:2, more preferably between about 1:2 and about 1:100, most preferably between about 1:4 and about 1:100. As demonstrated in the Examples, unlike planar gold quenching surfaces, which require the competitor molecule to achieve optimal efficiency of the device, Ag nanoparticle layers may contain little or no competitor molecule (i.e., where probe concentration exceeds competitor molecule concentration by several fold). Thus, use of the competitor can be an effective approach for equilibrating the potential relative intensity change (R-value) across an array; no two spots on an array would necessarily have to contain the same competitor:probe ratio.

The substrate can have a number of configurations depending on the nature and number of target nucleic acid molecules to be identified by a single chip.

According to one embodiment, the substrate is constructed using one or more nucleic acid probes, whether the same or different, all of which are directed to the same target molecule (perhaps, however, at different locations on the target). In this case, the probes can be attached to the metal nanoparticle layer in any location or over the substantially entire surface thereof.

According to another embodiment, the substrate is prepared with an array containing a plurality of discrete locations or “spots” where the probe molecules are bound to the metal nanoparticle layer. Preferably, a distinct probe is bound to each of the spots. Arrays of this type can be fabricated to contain in excess of 10², 10³, 10⁴, or even 10⁵ spots.

To distinguish between multiple fluorescent emissions emanating from a single location on the surface of the sensor chip (i.e., signal from one probe rather than another), the fluorescent emissions need only differ sufficiently to allow for resolution by the detector being utilized. Resolution of the signals can also depend, in part, on the nature of the emission pattern. For example, narrow emission maxima are more easily resolved than broad emission maxima that may interfere with emissions by other fluorophores. Thus, the selection of fluorophores should be made so as to minimize the interference given the sensitivity of the detector being utilized. By way of example, highly sensitive detectors can discriminate between the narrow emission maxima of semiconductor nanocrystals and dyes, allowing for separation of emission maxima that differ by about 1 nm or greater. Preferably, however, the emission maxima between the two or more fluorophores will differ by about 10 nm or greater or even 20 nm or greater, more preferably 30 nm or greater or even 40 nm or greater. Generally, the greater the separation between the emission maxima of the two or more fluorophores, the easier it will be to resolve their signals from overlapping locations on the surface of the substrate.

Referring now to FIG. 2, the substrate 10 is intended to be used as a component in the formation of a microfluidic device 20. The micro fluidic device 20 includes a polymer coating 22 adhered to or covalently bound the surface of the substrate 10, the polymer coating and substrate together defining one or more channels 24 having an inlet 26 and an outlet 28, whereby the nucleic acid molecule is present within the one or more channels 24. As illustrated in FIG. 2, the nucleic acid molecule is present at each of the “spots” 30 shown on the surface of the substrate that is exposed within the channel.

In use, the micro fluidic device 20 can have its inlet coupled to a valve or manifold to accept fluid from either a sample source (containing a sample to be analyzed) and a wash fluid source. The wash fluid source may contain water or another wash solution, such as a buffered saline solution. Fluid that flows over the surface of the device (with or without a dwell time) can be removed via outlet. Because the metal nanoparticle layer and substrate are light transmissive, illumining light can be directed through the bottom of the substrate and the detected fluorescent signal can be measured by the detector through the polymer coating. Any suitable optical set-up (bandpass filter, etc.) can be used to remove the illuminating light from interfering with the detector.

The microfluidic device 20 is intended to be used as a component in a biological sensor device or system. Basically, the device includes, in addition to the sensor chip, a light source that illuminates the sensor chip at a wavelength suitable to induce fluorescent emissions by the fluorophores associated with the one or more probes bound to the chip, and a detector positioned to capture any fluorescent emissions by the fluorophores.

The light source can be any light source that is capable of inducing fluorescent emissions by the selected fluorophores. Light sources that provide illumination wavelengths between about 200 nm and about 2000 nm are preferred. Exemplary light sources include, without limitation, lasers and arc lamps. Typical powers for lasers are at least about 1 mW; however, when used with an objective lens focusing the laser light to a small spot, as little as about 1 μW is sufficient. By way of example, Xenon arc lamps should be at least about 75 W.

The detector can be any detection device that is capable of receiving fluorescent emissions and generating a response to be examined by an operator of the biological sensor device. Suitable detectors include, without limitation, charge coupled devices (CCDs), photomultiplier tubes (PMTS), avalanche photodiodes (APDs), and photodiodes that contain a semiconductor material such as Si, InGaAs, extended InGaAs, Ge, HgCdTe, PbS, PbSe, or GaAs to convert optical photons into electrical current. Of these suitable detectors, the CCD is preferred because it can produce an image in extremely dim light, and its resolution (i.e., sharpness or data density) does not degrade in low light.

In addition to the above components, the biological sensor device can also include a notch filter positioned between the light source and the sensor chip and/or a bandpass filter positioned between the sensor chip and the detector. The notch filter will screen out a narrow band of photoradiation, i.e., at or near the excitation maxima of the selected fluorophore(s), so as to minimize any background excitation by materials present in or on the sensor chip or by non-quenched fluorophore(s). The bandpass filter controls the spectral composition of transmitted energy, typically though not exclusively by the effects of interference, resulting in high transmission over narrow spectral bands. By way of example, the bandpass filter can allow passage of light within a range that is not more than about 10 nm greater or less than the wavelength of the maximum emissions of the fluorophore(s). When two or more fluorophores are used having different emission maxima, the bandpass filter will emit passage of light within a larger wavelength band that extends from slightly below than the lowest wavelength maxima up to slightly higher than the highest wavelength maxima. Alternatively, when multiple fluorophores are used the emission signal can be split prior to passage through any filters (i.e., one for each fluorophore). Each split emission signal can include a separate bandpass filter that is configured for the emission maxima of one fluorophore but not the others.

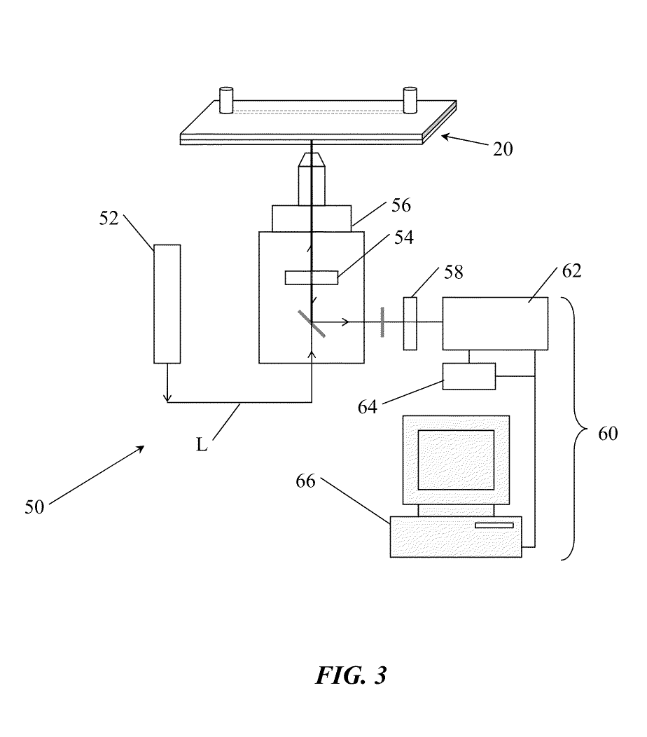

By way of example, FIG. 3 shows the configuration of one particular embodiment of the biological sensor device 50. The device includes a light source 52 that produces a focused beam of light L which is directed through a notch filter 54 and through an inverted microscope 56 (as shown, the notch filter is a component of the inverted microscope), where it contacts the microfluidic device 20 placed on a sample stage. Any fluorescent emissions are captured by the inverted microscope 56 and the signal passes through a bandpass filter 58 prior to reaching the detector device 60. As shown, the detector device 60 includes a spectrophotometer 62 coupled to a CCD 64, whose electrical output signal is directed to a computer 66 or similar device capable of receiving the electrical output and generating an image of the detected fluorescence emitted from the microfluidic device 20.

A further aspect of the present invention relates to a method of making a microfluidic device of the present invention. Basically, a substrate is provided which has a surface thereof coated with metal nanoparticles to form a discontinuous metal nanoparticle layer on the surface, and one or more nucleic acid molecules covalently attached to the metal nanoparticles, preferably at discrete locations on the surface, and to this substrate is attached a polymer coating, whereby the polymer coating and substrate surface together define one or more channels having an inlet and an outlet.

The substrate can be prepared as described above.

The polymer material is preferably a silicone elastomeric material such as polydimethylsiloxane (“PDMS”, e.g., Dow Corning Sylgard® 184) (McDonald et al., “Fabrication of Microfluidic Systems in poly(dimethylsiloxane),” Electrophoresis 21:27-40 (2000), which is hereby incorporated by reference in its entirety). PDMS is a particularly well studied material for the construction of micro fluidic systems. It is optically transparent, and has a refractive index that is much lower than that of silicon. PDMS has a hydrophobic surface after polymerization, but the surface of PDMS can be treated with a surfactant, oxygen and plasma, or atmospheric RF to become hydrophilic (Hong et al., “Hydrophilic Surface Modification of PDMS Using Atmospheric RF Plasma,” Journal of Physics: Conference Series 34:656-661 (2006), which is hereby incorporated by reference in its entirety). This hydrophilicity assists not only in bonding the polymer layer to the substrate, but also decreases surface tension and bio fouling within the microchannels to allow fluids to move easily along those channels. Chemical treatment methods are also available for improving the performance of PDMS (Lee and Voros, “An Aqueous-based Surface Modification of poly(dimethylsiloxane) with poly(ethylene glycol) to Prevent Bio fouling,” Langmuir 21:11957-11962 (2004), which is hereby incorporated by reference in its entirety).

Microchannels can be formed in the polymer coating prior to attachment. This is typically performed using, e.g., a photoresist mold containing an inverse feature that will define the structural features and dimensions of the microchannels. SU-8 is a typical photoresist mold material. After preparing the mold, the polymer coating is formed by introducing a liquid composition that includes the polymer precursors onto the surface of the mold, and then allowing the liquid composition to cure under conditions suitable to form the polymer coating. Briefly, for PDMS, the base and curing agents are thoroughly mixed together in a roughly 10:1 weight ratio, although variations in this ratio can also be used. After mixing, the liquid mixture should be placed in a desiccator under vacuum (e.g., 22 in. Hg) until the liquid mixture is free of bubbles, which should take about 10 to about 20 minutes. The mold substrate can then be placed into a holding device and the degassed liquid mixture can be poured slowly over the mold substrate so as to avoid trapping air. The mold and liquid can be placed in a vacuum oven (e.g., 80° C., 5 in. Hg) and cured. These conditions should avoid formation of gas bubbles or voids at the mold surface. After curing, the edges of the polymer layer can be trimmed, as needed, and the polymer layer removed from the mold substrate.

At this time the polymer layer has a hydrophobic surface, which will inhibit bonding to the surface of the metal nanoparticle-coated substrate. The surface of the polymer layer can be treated under suitable conditions with an activating agent that will render the surface hydrophilic. Examples of suitable activating agents are described above (O₂ plasma, surfactants, atmospheric RF treatment). By way of example, the polymer layer can loaded into a reactive ion etcher using 25% O₂ at 0.200 torr, 33.3% RF for 30 sec (or equivalent conditions).

Once treated, the polymer layer is then bonded to the device substrate. This is carried out by contacting the polymer layer to the surface of the substrate. To facilitate handling and placement of the polymer layer, it may be wetted in water or ethanol prior to initiating contact with the substrate. Contacting the device substrate should be carried out without significant delay after surface activation of PDMS, because the PDMS surface will return to its hydrophobic state after time. Once dry, bonding is complete. To facilitate a thorough fluid-tight seal between the polymer layer and the substrate, slight pressure can be applied while contacting, i.e., during the bonding process.

As is well known in the art, fluid ports can be designed for either introduction through the device substrate or through the polymer coating bonded thereto. For example, ports can be formed by creating vertical channels in the elastomeric polymer layer such that short glass tubing may be inserted into channels formed in the PDMS. Flexible tubing can be attached to these short glass tubes.

Once the fluid ports are installed, the microfluidic device can be pressure-tested by applying a volume of a flowable fluid to the fluid inlet port, and flowing the flowable fluid through the one or more microfluidic channels toward the fluid outlet port. Thereafter the device is ready for use.

The sample is preferably present in the form of a buffered solution or other medium suitable for use during hybridization. The sample itself can be either a clinical or environmental sample to which buffer or buffer salts are added, derived from purification of DNA or RNA from clinical or environmental specimens, or the product of a PCR reaction, etc. Basically, the sample can be in any form where the suspected nucleic acid target is maintained in a substantially stable manner (i.e., without significant degradation).

During use of the biological sensor device and the associated sensor chip, the presence of a target nucleic acid molecule in a sample can be achieved by first exposing the sensor chip to a sample under conditions effective to allow any target nucleic acid molecule in the sample to hybridize to the first and/or second regions of the nucleic acid probe(s) present on the sensor chip, illuminating the sensor chip with light sufficient to cause emission of fluorescence by the fluorophore(s), i.e., associated with the nucleic acid probe(s), and then determining whether or not the sensor chip emit(s) detectable fluorescent emission (of the fluorophore(s)) upon illumination. When fluorescent emission by the fluorophore(s) is detected from the chip, such detection indicates that the nucleic acid probe is in the non-hairpin conformation and, therefore, the target nucleic acid molecule is present in the sample.

The conditions utilized during the exposure step include hybridization and then wash conditions, as is typical during hybridization procedures. The hybridization and wash conditions can be carried out in buffered saline solutions either at or slightly above room temperature (i.e., up to about 35° C.). Alternatively, as is known in the art, the hybridization conditions can be selected so that stringency will vary. That is, lower stringency conditions will discriminate less between perfectly matched target nucleic acid molecules and non-perfectly matched nucleic acid molecules, whereas higher stringency conditions will discriminate between perfectly matched and non-perfectly matched nucleic acid molecules. In general, the highest stringency that can be tolerated by the probe and the intended target can be selected so as to minimize or completely avoid the possibility of a false positive response caused by hybridization to non-perfectly matched nucleic acid molecules. Detection performance can also be enhanced with the utility of a flow-through cell device by alleviating the rate-limited reaction. A flow-through device can increase the likelihood of the collision between the probe and target DNA at the reaction site due to the confined space and also the fluidic flow. In certain embodiments, detection is not carried out until the hybridization and wash procedures have been completed. In alternative embodiments, detection is carried out in real-time as a sample flows through the device.

An example of suitable stringency conditions is when hybridization is carried out at a temperature of at least about 35° C. using a hybridization medium that includes about 0.3M Na⁺, followed by washing at a temperature of at least about 35° C. with a buffer that includes about 0.3M Na⁺ or less. Higher stringency can readily be attained by increasing the temperature for either hybridization or washing conditions or decreasing the sodium concentration of the hybridization or wash medium. Other factors that affect the melting temperature of the hairpin probe include its GC content and the length of the stem (and whether the stem perfectly hybridizes intramolecularly). Nonspecific binding may also be controlled using any one of a number of known techniques such as, for example, addition of heterologous RNA, DNA, and SDS to the hybridization buffer, treatment with RNase, etc. Wash conditions can be performed at or below stringency of the hybridization procedure, or even at higher stringency when so desired. Exemplary high stringency conditions include carrying out hybridization at a temperature of about 50° C. to about 65° C. (from about 1 hour up to about 12 hours) in a hybridization medium containing 2×SSC buffer (or its equivalent), followed by washing carried out at between about 50° C. to about 65° C. in a 0.1×SSC buffer (or its equivalent). Variations on the hybridization conditions can be carried out as described in Sambrook et al., Molecular Cloning: A Laboratory Manual, Second Edition, Cold Spring Harbor Press, NY (1989), which is hereby incorporated by reference in its entirety.

The nucleic acid probes, used in preparing sensor chips of the present invention, can be selected so that they hybridize to target nucleic acid molecules that are specific to pathogens, are associated with disease states or conditions, contain polymorphisms that may or may not be associated with a disease state but can also be a forensic target or associated with a breeding trait for plants or animal. Other uses should be appreciated by those of ordinary skill in the art.

Pathogens that can be identified using the products and processes of the present invention include any bacteria, fungi, viruses, rickettsiae, chlamydiae, and parasites, but preferably those identified as belonging within the classifications listed as Biosafety Levels Two, Three, and Four by the U.S. Centers for Disease Control and Prevention, the National Institutes of Health, and the World Health Organization.

Exemplary bacterial pathogens that can be identified in accordance with the present invention include, without limitation: Acinetobacter calcoaceticus, Actinobacillus species (all species), Aeromonas hydrophile, Amycolata autotrophica, Arizona hinshawii (all serotypes), Bacillus anthracis, Bartonella species (all species), Brucella species (all species), Bordetella species (all species), Borrelia species (e.g., B. recurrentis, B. vincenti), Campylobacter species (e.g., C. fetus, C. jejuni), Chlamydia species (e.g., Chl. psittaci, Chl. trachomatis), Clostridium species (e.g., Cl. botulinum, Cl. chauvoei, Cl. haemolyticum, Cl. histolyticum, Cl. novyi, Cl. septicum, Cl. tetani), Corynebacterium species (e.g., C. diphtheriae, C. equi, C. haemolyticum, C. pseudotuberculosis, C. pyogenes, C. renale), Dermatophilus congolensis, Edwardsiella tarda, Erysipelothrix insidiosa, Escherichia coli (e.g., all enteropathogenic, enterotoxigenic, enteroinvasive and strains bearing K1 antigen), Francisella tularensis, Haemophilus species (e.g., H. ducreyi, H. influenzae), Klebsiella species (all species), Legionella pneumophila, Leptospira interrogans (e.g., all serotypes), Listeria species (all species), Moraxella species (all species), Mycobacteria species (all species), Mycobacterium avium, Mycoplasma species (all species), Neisseria species (e.g., N. gonorrhoea, N. meningitides), Nocardia species (e.g., N. asteroides, N. brasiliensis, N. otitidiscaviarum, N. transvalensis), Pasteurella species (all species), Pseudomonas species (e.g., Ps. mallei, Ps. pseudomallei), Rhodococcus equi, Salmonella species (all species), Shigella species (all species), Sphaerophorus necrophorus, Staphylococcus aureus, Streptobacillus moniliformis, Streptococcus species (e.g., S. pneumoniae, S. pyogenes) and particularly methicillin-resistant species of Streptococcus, Treponema species (e.g., T. carateum, T. pallidum, and T. pertenue), Vibrio species (e.g., V. cholerae, V. parahemolyticus), and Yersinia species (e.g., Y. enterocolitica, Y. pestis).

Exemplary fungal pathogens that can be identified in accordance with the present invention include, without limitation: Blastomyces dermatitidis, Cryptococcus neoformans, Paracoccidioides braziliensis, Trypanosoma cruzi, Coccidioides immitis, Pneumocystis carinii, and Histoplasma species (e.g., H. capsulatum, H. capsulatum var. duboisii).

Exemplary parasitic pathogens that can be identified in accordance with the present invention include, without limitation: Endamoeba histolytica, Leishmania species (all species), Naegleria gruberi, Schistosoma mansoni, Toxocara canis, Toxoplasma gondii, Trichinella spiralis, and Trypanosoma cruzi.

Exemplary viral, rickettsial, and chlamydial pathogens that can be identified in accordance with the present invention include, without limitation: Adenoviruses (all types), Cache Valley virus, Coronaviruses, Coxsackie A and B viruses, Cytomegaloviruses, Echoviruses (all types), Encephalomyocarditis virus (EMC), Flanders virus, Hart Park virus, Hepatitis viruses-associated antigen material, Herpesviruses (all types), Influenza viruses (all types), Langat virus, Lymphogranuloma venereum agent, Measles virus, Mumps virus, Parainfluenza virus (all types), Polioviruses (all types), Poxviruses (all types), Rabies virus (all strains), Reoviruses (all types), Respiratory syncytial virus, Rhinoviruses (all types), Rubella virus, Simian viruses (all types), Sindbis virus, Tensaw virus, Turlock virus, Vaccinia virus, Varicella virus, Vesicular stomatitis virus, Vole rickettsia, Yellow fever virus, Avian leukosis virus, Bovine leukemia virus, Bovine papilloma virus, Chick-embryo-lethal orphan (CELO) virus or fowl adenovirus 1, Dog sarcoma virus, Guinea pig herpes virus, Lucke (Frog) virus, Hamster leukemia virus, Marek's disease virus, Mason-Pfizer monkey virus, Mouse mammary tumor virus, Murine leukemia virus, Murine sarcoma virus, Polyoma virus, Rat leukemia virus, Rous sarcoma virus, Shope fibroma virus, Shope papilloma virus, Simian virus 40 (SV-40), Epstein-Barr virus (EBV), Feline leukemia virus (FeLV), Feline sarcoma virus (FeSV), Gibbon leukemia virus (GaLV), Herpesvirus (HV) ateles, Herpesvirus (HV) saimiri, Simian sarcoma virus (SSV)-1, Yaba, Monkey pox virus, Arboviruses (all strains), Dengue virus, Lymphocytic choriomeningitis virus (LCM), Rickettsia (all species), Yellow fever virus, Ebola fever virus, Hemorrhagic fever agents (e.g., Crimean hemorrhagic fever, (Congo), Junin, and Machupo viruses, Herpesvirus simiae (Monkey B virus), Lassa virus, Marburg virus, Tick-borne encephalitis virus complex (e.g., Russian spring-summer encephalitis, Kyasanur forest disease, Omsk hemorrhagic fever, and Central European encephalitis viruses), and Venezuelan equine encephalitis virus.

Thus, a further aspect of the present invention relates to a method of detecting presence of a pathogen in a sample that is carried out by performing the above-described method (of detecting the presence of the target nucleic acid molecule) when using a micro fluidic device containing a nucleic acid probe specific for hybridization with a target nucleic acid molecule of a pathogen.

Yet another aspect of the present invention relates to a method of genetic screening that is carried out by performing the above-described method (of detecting the presence of the target nucleic acid molecule) when using a microfluidic device containing a nucleic acid probe specific for hybridization with a genetic marker. As noted above, the genetic marker can be associated with disease states or conditions, contain polymorphisms that may or may not be associated with a disease state but can also be a forensic target or associated with a breeding trait for plants or animal.

### EXAMPLES

The following examples are provided to illustrate embodiments of the present invention but are by no means intended to limit its scope.

### Materials & Methods for Examples 1-5

DNA Probes: The accompanying examples employed a previously described DNA probe (5′-TCG TTA GTG TTA GGA AAA AAT CAA ACA CTC GCG A-3′, SEQ ID NO: 1). This probe was designed based on gene-folding analysis of the Bacillus anthracis pag gene (Strohsahl et al., “Identification of High-stringency DNA Hairpin Probes by Partial Gene Folding,” Biosens. Bioelectron. 23:233-240 (2007), which is hereby incorporated by reference in its entirety). The multiplex study employed probes designed to be specific for uropathogenic E. coli (Eco3a: 5′-CTG AGC CTC ACC AAC GAA GAA CTG GCT CAG-3′, SEQ ID NO: 2) and Enterobacter cloacae (Enterbact3a: 5′-GCG GCT TAA CAC TAA CTC GTT ATC CGC-3′, SEQ ID NO: 3). Probe design was carried out according to the procedure outlined in Strohsahl et al., “Identification of High-stringency DNA Hairpin Probes by Partial Gene Folding,” Biosens. Bioelectron. 23(2):233-240 (2007), which is hereby incorporated by reference in its entirety. In brief, segments of genomic DNA obtained from public databases were subjected to secondary structure prediction using the computer program RNAStructure. Candidate probes were selected from the secondary structure prediction by visual inspection, then excised from the genomic context and re-subjected to folding. The energy of the duplex was also predicted. The two probes, Eco3a and Enterbact3a, used in this study were chosen based on their strongly favorable predicted folding and duplex-forming energies.

All probes were purchased from Midland Certified, Inc., and bear a 3′-tetramethyl rhodamine (TMR) fluorophore (Abₘₐₓ, 559 nm; Emₘₐₓ, 583 nm) and a 5′ trityl-thiol.

Data acquisition: Fluorescence measurements were performed using an Olympus BX-60 fluorescence microscope equipped with a thermoelectrically (TE) cooled charge coupled device (CCD). Samples were excited with incident light from a Hg lamp (100-W), which was filtered with an excitation bandpass filter (531±20 nm), reflected by a dichroic mirror, and guided through a 10× objective lens. The emitted light was collected by the CCD after being directed from the sample, through the objective, the dichroic mirror, and an emission bandpass filter (593±20 nm). Fluorescence images were analyzed using Image J software (Abramoff et al., “Image Processing with ImageJ,”Biophoton. Int. 2004, 11:36 (2004), which is hereby incorporated by reference in its entirety).

### Example 1

### Nanostructured Ag Substrate Fabrication

Nanostructured Ag substrates were fabricated by covalent attachment of Ag nanoparticles to thiolated glass substrates. Microscope glass slides (VWR, Cat. No. 48300-025) were first diced into individual chips with dimensions of 1.7 cm×2.5 cm using a diamond scribe. These glass chips were cleaned by soaking them in piranha solution (sulfuric acid: hydrogen peroxide 3:1; Caution: piranha solution is caustic and reacts vigorously with organics) for 15 min. The glass chips were then rinsed with distilled, deionized (DDI) water, soaked in a 10 M NaOH solution for 5 min, rinsed again with DDI water, and finally dried under nitrogen gas.

Surfaces of the clean glass chips were next silanized by immersion in a 1% MPTS (3-mercaptopropyl trimethoxysilane), 95% methanol, and 4% 1 mM acetic acid solution at room temperature for 30 min. The chips were then sonicated (300-W Vibracell probe sonicator, Sonic & Material Inc.) in a 95% ethanol: 5% water solution for 2 min, and dried under nitrogen gas.

DNA probes were printed using a Virtek Chip Writer Pro (Virtek Vision Inc., Ontario, Canada) microarrayer and an SMP2XB pin (Arrayit Corporation, ˜1 nL spot volume, ˜120 μm spot diameter). The DNA probe solution used for printing consisted of 900 nM DNA probe and 180 nM mercaptopropanol (MP) in buffered saline containing 10% glycerol (250 mM NaCl, 10 mM cacodylic acid, and 0.25 mM EDTA (ethylenediaminetetraacetic acid), pH=7). DNA self-assembly on the nanostructured Ag substrate surface was accomplished by allowing the spots to immobilize for 1 h at 75% humidity in the dark.

Next, non-specifically absorbed DNA hairpin probes were removed by immersing the substrates in boiling DDI water for 30 s. Substrates were then air dried and left in the dark for 45 min.

### Example 2

### Microfluidic Device Fabrication

Once the probe spots were immobilized on the substrate surfaces as described in Example 1, the substrates were covalently bound to the channel-embedded PDMS replicates.

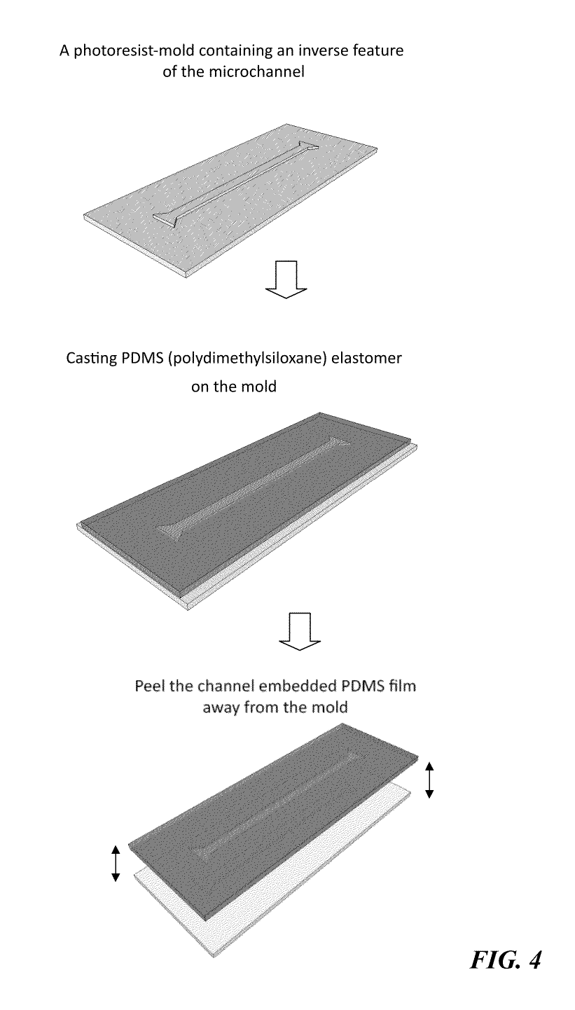

The microfluidic device was prepared with a single microchannel 2 cm in length, 1 mm in width, and 50 μm in height (FIG. 2), connected to two isosceles trapezoid fluidic reservoirs (top base: 1 mm, bottom base: 3.75 mm, and height: 1.25 mm) at both ends. Total fluid volume of the channel was 1 μl. The channel-embedded PDMS replicates were fabricated by casting 20 grams of the PDMS elastomer mixture (at a prepolymer: curing agent ratio of 10:1 (w/w), Sylgard 184 kit, Dow Corning, Midland, Mich.) over a SU-8 photoresist mask (see FIG. 4). The photoresist mask has an inverse feature of the microchannels, and was patterned using standard soft lithography at Stanford Microfluidics Foundry (Stanford, Calif.).

After initial casting, the overlaying PDMS mixture was cured at 110° C. for 2 h, and the cured channel-embedded PDMS replicates were peeled away from the mask using forceps (see FIG. 4). Inlet and outlet of the channels were created by punching holes at both reservoirs using blunt-end needles (20G×½″ stainless steel, Small Parts, Inc, FL).

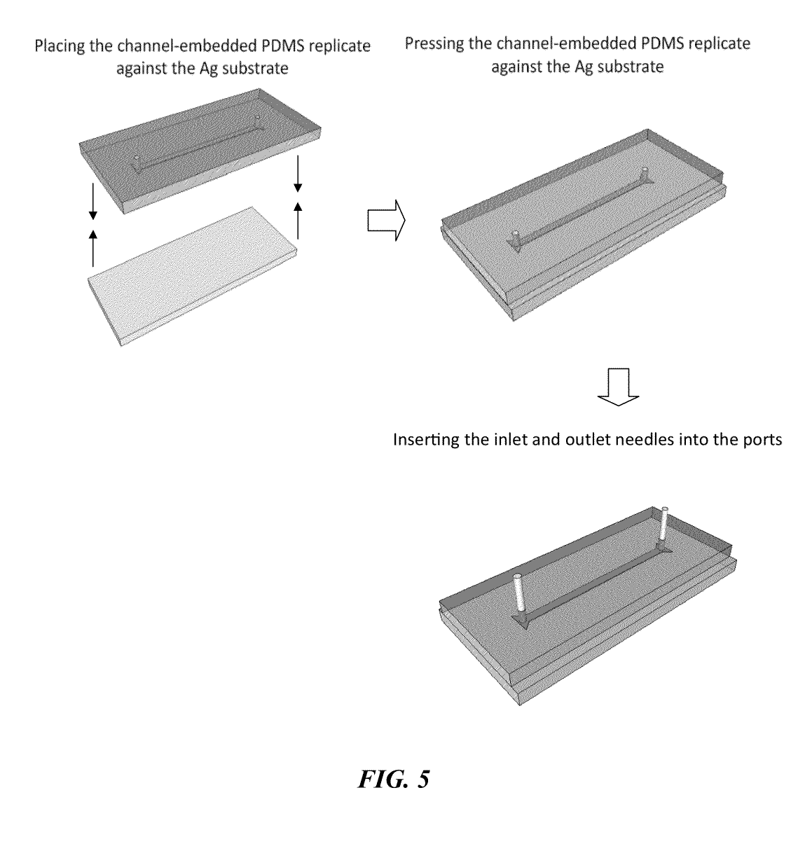

The channel-embedded PDMS replicates were next bound to individual probe-immobilized Ag substrates (see FIG. 5). One standard approach to creating a covalent O—Si—O bond between PDMS and a glass substrate is through oxygen plasma treatment. As PDMS is composed of repeating —OSi(CH₃)₂— chemical units, these can be converted to silanol (OH—Si) upon oxygen plasma exposure. These rapidly react with analogous groups on the glass surface (Sia et al., “Microfluidic Devices Fabricated in Poly(dimethylsiloxane) for Biological Studies,” Electrophoresis 24(21):3563-3576 (2003), which is hereby incorporated by reference in its entirety). Thus, after PDMS replicates had been cured and punched, the surface was treated with UV-ozone (Bio force Nanosciences, Inc, model UV-TC.110) with the feature sides facing up for 3 min. The UV-ozone treated-PDMS replicates were next placed in immediate contact with nucleic acid labeled Ag-nanoparticle coated substrates (see FIG. 5). Finally, the assembled PDMS replicate/substrate complexes were heated in an oven at 110° C. for 10 min prior to storage. After channel assembly, inlet and outlet tubing (polyethylene, I.D. 0.55 mm, O.D. 0.965 mm) was connected to the channel reservoirs via blunt-end needles (22G×½″ stainless steel, Small Parts, Inc., FL). Inlet tubing was connected to a 1 ml syringe (Norm-Ject®) mounted on a syringe pump (model: NE-1000 Multi-Phase™, New Era Pump Systems Inc., NY). Outlet tubing was connected to a waste reservoir.

Unlike traditional micro fluidic devices, where the channel-embedded PDMS blocks are placed in immediate contact with the entire mating surface area of the glass substrate base, the device described herein prevents continuous direct contact between the mating surfaces of the PDMS replicates and the glass slides since the base is partially covered with Ag nanoparticles. Thus, it was not clear a priori whether bonding could be achieved between the microfluidic channel and the sensor substrate. However, preliminary trials indicated that covalent bonding between PDMS replicates and Ag nanoparticle coated substrates was readily achievable using the protocol described above. The assembled microfluidic devices showed no evidence of channel collapsing. Furthermore, flow rates of up to 30 μl/min (with a duration up to 30 min) were readily sustained without any evidence of channel leakage. Because this flow rate was more than sufficient for DNA detection studies described in the subsequent examples, fluidic flow velocities higher than 30 μl/min were not tested. It is believed that this is the first demonstration of direct covalent bonding between PDMS blocks and a metal nanoparticle-coated glass substrate.

Without being bound by belief, it is believed that sufficient covalent bonds are formed between the bare glass space remaining between individual Ag nanoparticles and the PDMS surfaces. To verify the accuracy of this belief, an attempt was made to bond PDMS replicates to a continuous planar Au film using the same assembly method (UV-Ozone followed by 110° C. treatment) as a control. Consistent with the belief, the PDMS replicates could be easily peeled away from the continuous Au surface with a pair of forceps, whereas the PDMS replicates stayed firmly attached to the nanostructured Ag substrate and could not be separated from each other without disrupting the PDMS.

### Example 3

### DNA Detection in a Microfluidic Device

After successfully addressing the challenge of assembling a leakage-free device, the utility of this microfluidic system for arrayed DNA detection was examined. In this example, different probe sequences were spotted on the substrate surface using a microarrayer. This approach not only provides the potential for multiplex detection, but also dramatically reduces reagent consumption.

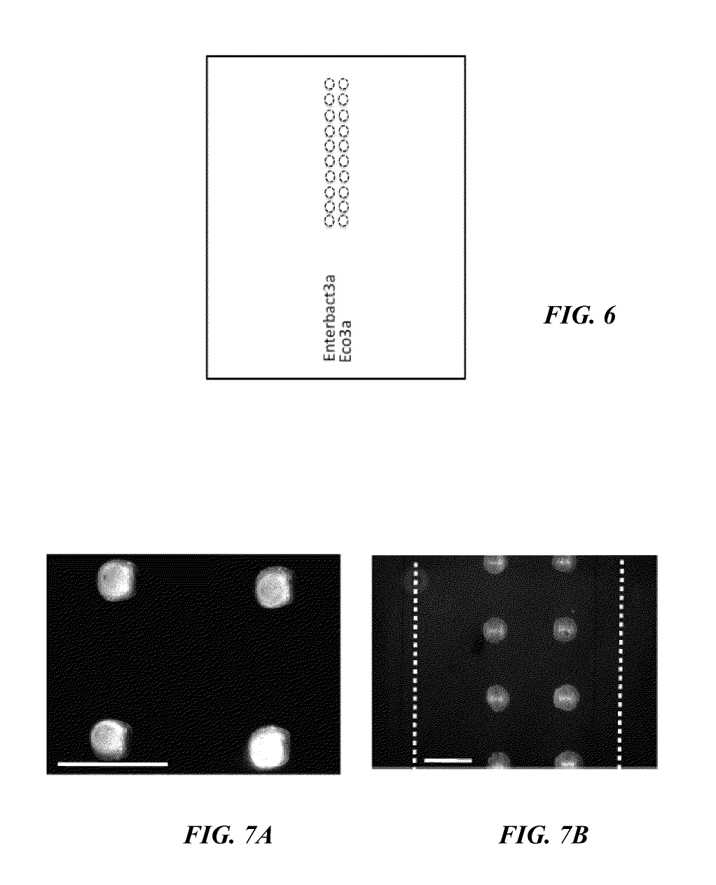

In this example, arrays of the Bacillus anthracis probe (2 columns, each column consisted of 10 probe spots) were first printed on the substrate surface and the substrate was next integrated with a channel-embedded PDMS replicate using the assembly protocols described above (FIG. 6). As a final step prior to detection, hairpin reformation was promoted by adding 1 μl of buffered saline (500 mM NaCl, 20 mM cacodylic acid, and 0.5 mM EDTA, pH=7) into the channel for 45 min (room temperature, in the dark).

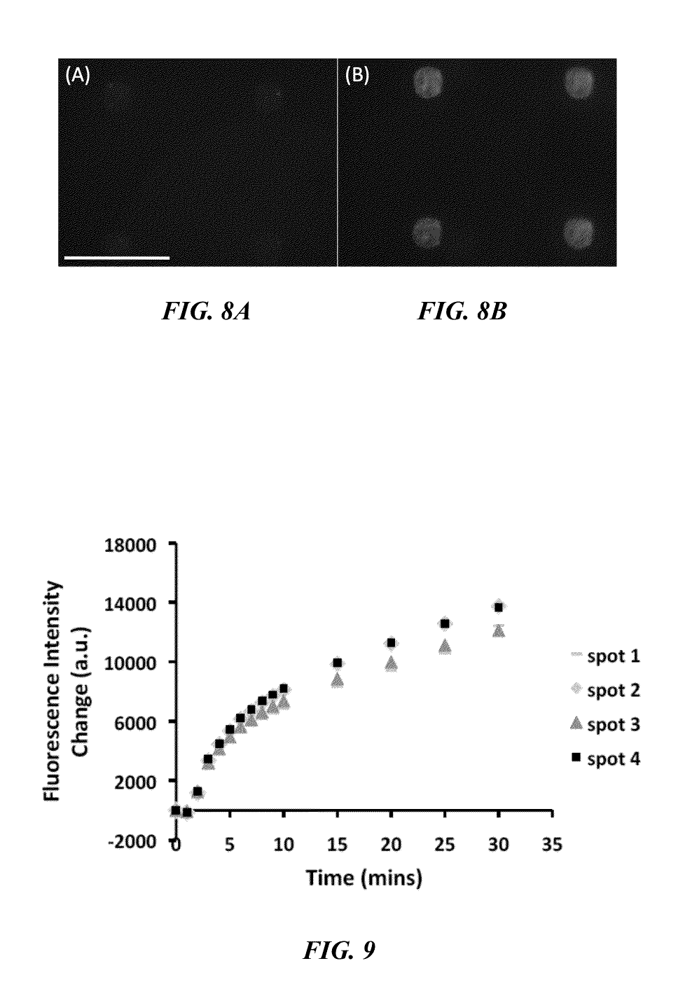

Using a standard fluorescence microscope for imaging, it was possible to observe 4 spots within one fluorescence image under 10× objective magnification, and 8 spots under 4× objective magnification (FIGS. 7A-B). These spots are approximately circular with a diameter of ˜90 μm. By arraying spots in columns, it was possible to incorporate two columns of spots into a single channel. One could further decrease the inter-spot distance to accommodate more DNA probe spots into the channel and hence increase the multiplex capability of the device. Exposure of a solution containing synthetic target to these probe-immobilized channels confirmed the device's ability to support DNA detection in an array format as evidenced by clear increases in fluorescence (compare FIGS. 8A-B).

### Example 4

### Real Time Detection Versus Target Flowing Time

In this example, target solutions with different concentrations of nucleic acids in buffered saline (500 mM NaCl, 20 mM cacodylic acid, and 0.5 mM EDTA, pH=7) were delivered into the channel via a syringe pump at a flow rate of 0.5 μl/min for 30 minutes. During this time, the fluorescence signal change was monitored in real-time. FIG. 9 shows the real-time detection responses from four different spots on a single substrate, in which the fluorescence intensity change was obtained by subtracting the signals at each time point from the fluorescence intensity at 0 second (Iₜᵢₘₑ-I₀). As shown in FIG. 9, 30 min of target treatment in the channel resulted in a ˜12000 a.u. increase in fluorescence intensity change (with a baseline signal of approximately 15000 a.u.). While this signal change is lower (10-15 fold lower) than the intensity change observed from the bulk non-fluidic detection environment, it is more than sufficient to detect a positive result. The decrease in fluorescence intensity change observed in the microfluidic setting might be attributed to non-specific interactions between PDMS and target analyte molecules or optical transmission loss due to PDMS scattering and absorption.

Due to the inherent hydrophobic property of PDMS, the PDMS surface is very prone to non-specific interactions, particularly with other hydrophobic species. It is plausible that some single stranded DNA molecules were non-specifically attracted to the PDMS surface through their unshielded hydrophobic base. This undesired interaction between PDMS and analytes could affect analyte transport, resulting in poor detection sensitivity (Zhang et al., ““Click” Chemistry-based Surface Modification of Poly(dimenthylsiloxane) for Protein Separation in a Microfluidic Chip,” Electrophoresis 31:3129 (2010), which is hereby incorporated by reference in its entirety). One common solution to overcome this difficulty is surface modification. Polymers such poly (ethylene glycol) or Pluronic f127 have been the prime surface modification candidates to prevent non-specific interactions (Kawaguchi et al., “Prevention of Nonspecific Adsorption onto a Poly(dimethylsiloxane) Microchannel in a Microsensor Chip by Using a Self-Assembled Monolayer,” J. Micro/Nanolith. MEMS MOEMS 9:013012 (2010); Reimhult et al., “QCM-D Analysis of the Performance of Blocking Agents on Gold and Polystyrene Surfaces,” Langmuir 24:8695 (2008); Wang et al., “Total Internal Reflection Fluorescence Flow Cytometry,” Anal. Chem. 80:9840 (2008), each of which is hereby incorporated by reference in its entirety).

Meanwhile, although PDMS films appear to be optically transparent to the naked eye, the films in fact exhibit a light-absorbing characteristic at the UV/VIS wavelength range. However, the intensity is significantly lower than their absorption in the NIR region (Cai et al., “Raman, Mid-infrared, Near-infrared and Ultraviolet-visible Spectroscopy of PDMS Silicone Rubber for Characterization of Polymer Optical Waveguide Materials,” J. Molecular Structure 976:274 (2010), which is hereby incorporated by reference in its entirety). It has been shown that a PDMS film exhibits mild light extinction characteristic in the visible light window. In addition, the rubbery polymeric network can also cause marked light scattering (Seiffert et al., “Reduced UV Light Scattering in PDMS Microfluidic Device,” Lab. Chip 11:966 (2011), which is hereby incorporated by reference in its entirety). These factors, combined with the possibility of dust and impurities getting trapped in the PDMS mixer during polymer preparation, can substantially lower the optical transmission after light travels through the polymer film, resulting in a loss in fluorescence intensity. One approach to minimizing fluorescence intensity loss by PDMS extinction is through the use of an inverted microscope. By using an inverted microscope (illustrated in FIG. 3), the incident light will travel to the reaction surface through the substrate base as opposed to the PDMS replicate, thereby diminishing signal loss.

### Example 5

### Utility of the Device for Real-Time Quantitative Analysis

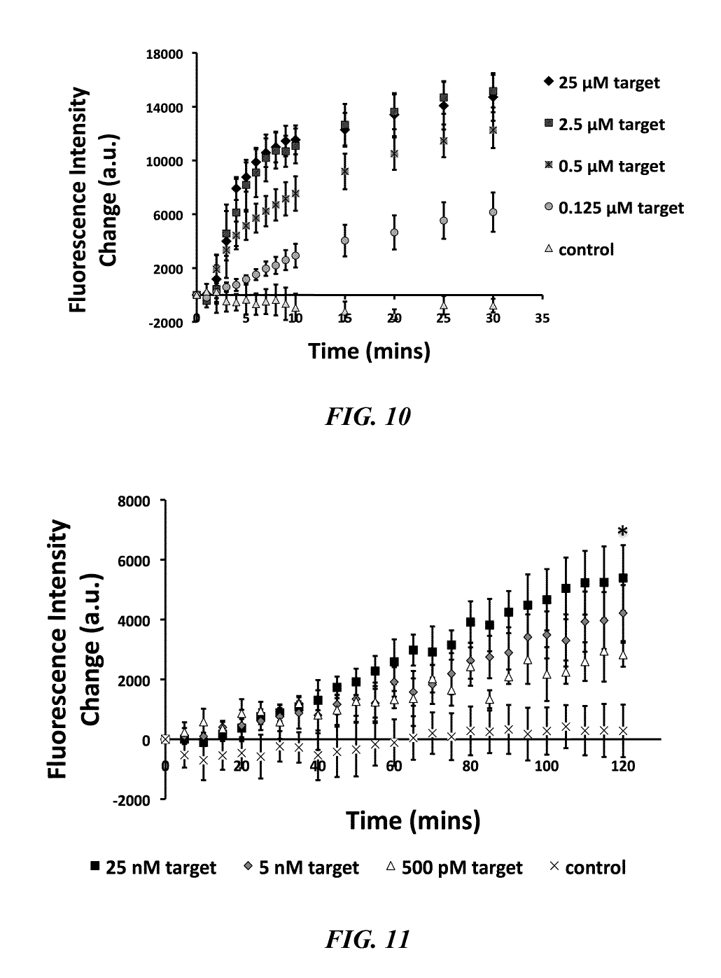

To evaluate the utility of the device for real-time quantitative analysis, the probe-immobilized microchannels were challenged with target solutions containing different concentrations (0.125, 0.5, 2.5, and 25 μM). Target solutions were delivered into the microfluidic channels at a flow velocity of 0.5 μl/min, and fluorescence responses from the probe spots were recorded at time points of 0, 1, 2, 3, 4, 5, 6, 7, 8, 9, 10, 15, 20, 25, and 30 min during a continuous target fluid flow. Fluorescence intensity changes were obtained by subtracting the signals at each time point from the fluorescence intensity at 0 min, (Iₜᵢₘₑ-I₀). As shown in FIG. 10, the fluorescence signal increased as a function of target delivery time, except for the control (no target) group. Detection time as low as ˜6 min, corresponding to only 3 μl of the target solution, was sufficient to discern a signal difference between each group. No significant difference was observed between the 2.5 μM and the 25 μM group, suggesting that a 2.5 μM target concentration was sufficient to saturate the probe molecules on the substrate surfaces. The errors observed in each data point primarily resulted from chip-to-chip variations, as opposed to intra chip (inter spots on the same substrate) variations. It is believed that this variation is likely due to variability in the array printing process.

### Example 6

### Detection Responses from Microfluidic Channels Upon

Introduction of Target DNA Solutions Containing Different

### Concentrations

To demonstrate the capability of this microfluidic device to detect lower concentrations of target analytes, sensors were exposed to 25 nM, 5 nM, 500 μM, and 0 M target solutions. Here, analyte solutions were delivered continuously at a speed of 0.5 μl/min for 2 h. Fluorescence images of the DNA probe spots on the microchannel floors were acquired at 5 min time intervals after target injection. As one would expect, longer delivery times were required for these low-concentration solutions (FIG. 11). However, the observed minimum detection time is significantly less than what was required in previous studies of non-fluidic systems. For example, overnight incubations were necessary in order to generate a detection signal from 10 pM target solutions (Strohsahl et al., “Identification of High-stringency DNA Hairpin Probes by Partial Gene Folding,” Biosens. Bioelectron. 23(2):233-240 (2007), which is hereby incorporated by reference in its entirety). It is likely that detection time can be further reduced by increasing target delivery speed, thus allowing a more efficient target analyte transport to the reaction surfaces. Statistical analysis shows that the detection signals (at the 120 min time points) from different concentrated target solutions are all significantly different from the control group. In addition, each group is statistically different from all other groups.

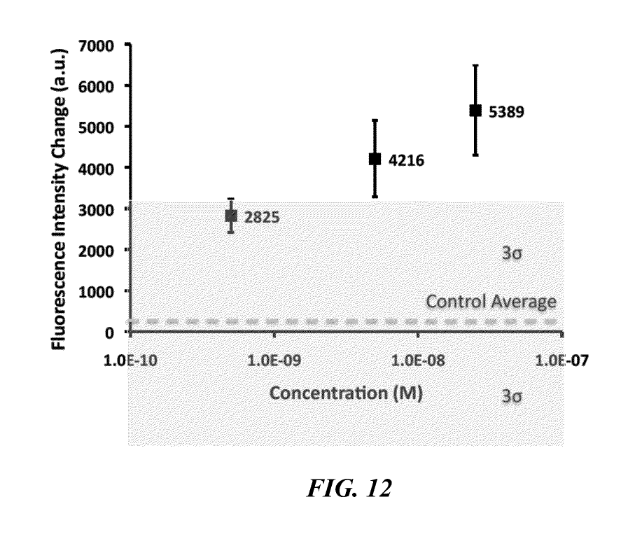

A dose response (FIG. 12) plot showing the end-point fluorescence intensity changes from the devices versus target concentrations indicated that both the 5 nM and 25 nM groups generated signals that are 3 standard deviations (s.d.) different from the control group (buffer only, no target), whereas the signals obtained from the 500 pM group still lay within the 3 s.d. of the control group. This indicates that the sensitivity of this detection layout is on the order of 5 nM. However, system optimization has not been undertaken to strengthen its performance. This may be accomplished through optimizations in target flowing velocity and channel dimensions, or implementing ways to prevent non-specific interactions between the analyte and PDMS. Similar to the previous study, signal variations between each device channel were observed (FIGS. 11 and 12). This variation is likely due to array printing inconsistencies. Optimization in printing parameters including printing velocity or z distance can be further investigated to improve detection signal consistency.

### Example 7

### Real-Time Fluorescence Responses During a Continuous Target Solution Flow for a Multiplex Sensor

An ideal biosensor should exhibit multiplexing capability, as detecting multiple target DNA sequences can simultaneously increase sample throughput and also enable quantitative analyses of multiple targets in one example. Parallel detection is also tantamount to low reagent consumption and reduction in laborious procedures that are usually required in non-multiplex settings.

To demonstrate multiplex detection in the microfluidic device, probes containing different DNA sequences (Enterbact3a and Eco3a) were printed in two different rows on Ag substrates (see FIG. 6). A 500 nM target solution containing DNA complementary to the Enterbact3a probes was then flowed through the channel. The target DNA molecules were delivered to the microfluidic device at a flow rate of 0.5 μl/min for 30 min.

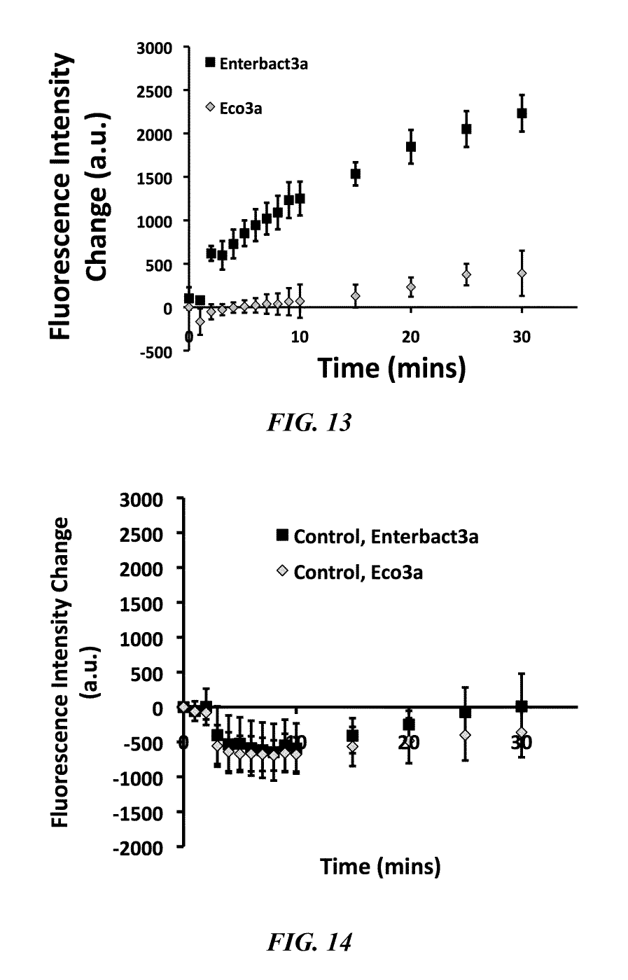

FIG. 13 shows the real-time fluorescence intensity change during a continuous fluid flow of a 500 nM Enterbact3a target solution in the microchannel. Fluorescence intensity change from the Enterbat3a probe spots was found to be ˜6 fold higher (2232) than the fluorescence intensity from the Eco3a group (390) after 30 min target exposure time. A detection time of less than 5 min was sufficient to generate distinguishable signals from the negative control groups (FIG. 13).

Though there is minimal detection response from the Eco3a probe spots upon target introduction, the response did appear to be greater than the negative control, in which only buffer was applied to the system (FIG. 14). This subtle increase in detection response that was observed from the Eco3a probe spots could be due to non-specific interactions. Modifying the hybridization environment to more stringent conditions (higher temperature or lower salt concentration) should reduce these background signals. It was also observed that in response to identical amounts of target DNA molecules, the detection responses obtained in this example was ˜5 fold lower than the signal change obtained from the Bacillus Anthracis detection in Example 6. This difference could be due to subtle differences in the ability of the two probes to assemble on the Ag nanoparticle surface, or may result from differences in hybridization kinetics between the two target DNA sequences.

The preceding Examples demonstrate a real-time and arrayable DNA biosensor in a microfluidic device using Ag nanoparticle-bound DNA hairpin probes. At a target flow rate of 0.5 μl/min, only 4 μl of 125 nM target solution was required to elicit a significant detection signal. Subsequent efforts further established this device's capability for multiplex detection. While only 4-8 sample spots could be identified at once with the current imaging (under 10× and 4× objective magnification, respectively) and microarray setup, higher sample throughput can be achieved by decreasing inter-spot distance or through the use of a fluorescence scanner. The preceding Examples confirm the adaptability of the Ag nanoparticle-enabled DNA sensor to a microfluidic format.

In addition to the foregoing examples, it should be appreciated that additional design considerations can be implemented. Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

All of the features described herein (including any accompanying claims, abstract and drawings), and/or all of the steps of any method or process so disclosed, may be combined with any of the above aspects in any combination, except combinations where at least some of such features and/or steps are mutually exclusive.

What is claimed:

1. A micro fluidic device comprising:
a substrate having a surface covered by an discontinuous metal nanoparticle layer;
a first nucleic acid molecule that is characterized by being able to (i) self-anneal into a hairpin conformation and (ii) hybridize specifically to a target nucleic acid molecule, the first nucleic acid molecule having first and second ends, where the first end is tethered to the metal nanoparticle layer and the second end is bound by a fluorophore; and
a polymer coating adhered to (or covalently bound to) the surface of the substrate, the polymer coating and substrate together defining one or more channels having an inlet and an outlet;
whereby the first nucleic acid molecule is present within the one or more channels, and whereby when the first nucleic acid molecule is in the hairpin conformation, the metal nanoparticle layer substantially quenches fluorescent emissions by the fluorophore, and when the first nucleic acid molecule is in a non-hairpin conformation fluorescent emissions by the fluorophore are surface plasmon-enhanced.

2. The microfluidic device according to claim 1 wherein the substrate comprises an oxide glass or a metal.

3. The microfluidic device according to claim 2 wherein the oxide glass comprises SiO₂.

4. The microfluidic device according to claim 1 wherein the polymer is PDMS.

5. The microfluidic device according to claim 1 wherein the discontinuous metal nanoparticle layer has a surface area coverage of less than about 50 percent.

6. The microfluidic device according to claim 1 wherein the discontinuous metal nanoparticle layer has a surface area coverage of less than about 30 percent.

7. The microfluidic device according to claim 1 wherein the discontinuous metal nanoparticle layer is characterized by a surface roughness of between about 0.7 nm and about 3 nm.

8. The microfluidic device according to claim 5 wherein the discontinuous metal nanoparticle layer is less than about 50 nm thick.

9. The microfluidic device to claim 1 wherein the discontinuous metal nanoparticle layer comprises gold, silver, platinum, titanium, copper, gallium, aluminum, doped silicon, or doped germanium.

10. The microfluidic device according to claim 1 wherein the substrate is light transmissive.

11. The microfluidic device according to claim 1 wherein the substrate is capable of quenching fluorescence of the fluorophore.

12. The microfluidic device according to claim 11 wherein the substrate comprises a metal that is different from the metal used for the discontinuous metal nanoparticle layer.

13. The microfluidic device according to claim 12 wherein the substrate comprises a metal selected from the group consisting of gold, platinum, titanium, copper, gallium, aluminum, doped silicon, and doped germanium.

14. The microfluidic device according to claim 1 wherein the polymer coating and substrate together define two or more channels having an inlet and an outlet.

15. A biological sensor device comprising:
the micro fluidic device according to claim 1;
a light source that illuminates the substrate at a wavelength suitable to induce fluorescent emissions by the fluorophore(s); and
a detector positioned to detect fluorescent emissions by the fluorophore(s).

16. A method of detecting the presence of a target nucleic acid molecule in a sample comprising:
passing an aqueous solution through the one or more channels of the microfluidic device according to claim 1 under conditions effective to allow any target nucleic acid molecule in the sample to hybridize to the nucleic acid molecules, causing the nucleic acid molecules to adopt the non-hairpin conformation;
illuminating the micro fluidic device with light sufficient to cause emission of fluorescence by the fluorophore; and
determining whether or not the microfluidic device emits fluorescent emissions of the fluorophore upon said illuminating wherein fluorescent emission by the fluorophore indicates that a nucleic acid molecule is in the non-hairpin conformation and therefore that its target nucleic acid molecule is present in the sample.

17. The method according to claim 16 wherein the target nucleic acid molecule is specific for a pathogen, a disease state, a genetic marker, or a forensic target, or associated with a breeding trait for a plant or animal.

18. A method of making a microfluidic device comprising:
providing a substrate with a surface thereof coated with metal nanoparticles to form a discontinuous metal nanoparticle layer and one or more nucleic acid molecules covalently attached to the discontinuous metal nanoparticle layer; and
attaching a polymer layer to the substrate surface, whereby the polymer and substrate surface together define one or more channels having an inlet and an outlet.

19. The method according to claim 18 wherein the substrate comprises an oxide glass or a fluorescence quenching metal.

20. The method according to claim 18 wherein said providing comprises:
coating a surface of a substrate with metal nanoparticles to form the discontinuous metal nanoparticle layer; and
covalently attaching a first end of the one or more nucleic acid molecules to the discontinuous metal nanoparticle layer.

21. The method according to claim 20 wherein said coating a surface of a substrate with metal nanoparticles to form the discontinuous metal nanoparticle layer comprises covalently attaching the metal nanoparticles to the substrate surface.

22. The method according to claim 20 wherein said coating is carried out in the absence of masking the substrate surface.

23. The method according to claim 20 wherein said covalently attaching one or more nucleic acid molecules is carried out before said attaching a polymer to the substrate.

24. The method according to claim 20 wherein said covalently attaching one or more nucleic acid molecules is carried out after said attaching a polymer to the substrate.

25. The method according to claim 18 wherein said attaching the polymer is carried out on regions of the substrate surface comprising the discontinuous metal nanoparticle layer.

26. The method according to claim 18 wherein the discontinuous metal nanoparticle layer has a surface area coverage of less than about 50 percent.

27. The method according to claim 18 wherein the discontinuous metal nanoparticle layer has a surface area coverage of about 20 percent.

28. The method according to claim 18 wherein the polymer is PDMS.

29. The method according to claim 18 wherein said attaching a polymer layer to the substrate comprises covalently bonding the polymer to the substrate.

30. The method according to claim 18 wherein the one or more nucleic acid molecules are different from one another and characterized by being able to (i) self-anneal into a hairpin conformation and (ii) hybridize specifically to a target nucleic acid molecule, each of the plurality of nucleic acid molecules having first and second ends, which first end is attached to the metal nanoparticle layer and which second end is bound to a fluorophore.

31. A micro fluidic device comprising:
a substrate having a surface covered by a discontinuous metal nanoparticle layer;
a nucleic acid molecule tethered to the metal nanoparticle layer; and
a polymer coating adhered to or covalently bound the surface of the substrate, the polymer coating and substrate together defining one or more channels having an inlet and an outlet, whereby the first nucleic acid molecule is present within the one or more channels.

32. The microfluidic device according to claim 31 wherein the substrate comprises an oxide glass or a metal.

33. The microfluidic device according to claim 32 wherein the oxide glass comprises SiO₂.

34. The microfluidic device according to claim 31 wherein the polymer is PDMS.

35. The microfluidic device according to claim 31 wherein the discontinuous metal nanoparticle layer has a surface area coverage of less than about 50 percent.

36. The microfluidic device according to claim 31 wherein the discontinuous metal nanoparticle layer has a surface area coverage of about 20 percent.

37. The microfluidic device according to claim 31 wherein the polymer coating is covalently bonded to the substrate surface at regions between metal nanoparticles.


SEQUENCE LISTING (3 sequences)

SEQ ID NO: 1 - DNA, 33 bp, artificial
  Probe for Baccillus anthracis pag gene
tcgttagtgttaggaaaaaatcaaacactcgcg

SEQ ID NO: 2 - DNA, 30 bp, artificial
  Probe for uropathogenic E. coli (Eco3a)
ctgagcctcaccaacgaagaactggctcag

SEQ ID NO: 3 - DNA, 27 bp, artificial
  Probe for Enterobacter cloacae (Enterobact3a)
gcggcttaacactaactcgttatccgc